(19) United States
(12) Patent Application Publication
(10) Pub. No.: US 2026/0291644 A1
(43) Pub. Date: Sep. 24, 2026

(54) FRAMEWORK FOR MULTIPLE TRANSPORT BLOCK SCHEDULING

(71) Applicant: QUALCOMM Incorporated, San Diego, CA (US)

(72) Inventors: Tal OVED, Modiin (IL); Gideon Shlomo KUTZ, Ramat Hasharon (IL); Assaf TOUBOUL, Netanya (IL)

(21) Appl. No.: 19/474,078

(22) PCT Filed: May 6, 2024
(86) PCT No.: PCT/US2024/027961

§ 371 Date: Oct. 9, 2025

(30) Foreign Application Priority Data
May 11, 2023 (IL) 302882

(51) Int. Cl. H04L 1/00; H04L 1/1812; H04L 1/1867

(52) U.S. Cl. CPC H04L 1/0057; H04L 1/0003; H04L 1/0009; H04L 1/1819; H04L 1/1887; H04L 1/1893; H04L 1/1896

(57) ABSTRACT

Methods, systems, and devices for wireless communications are described. A Multi Incremental Redundancy Scheme (MIRS) may be a spectral efficiency (SPEF) adaptation scheme for finding an optimal SPEF for transmission of a transport block. A network may transmit a scheduling and signaling framework to allow for multiple transport blocks to be scheduled in a single downlink resource allocation for transmissions that utilize MIRS. For example, a network may schedule a single resource allocation for the transmission of multiple transport blocks from the network to the UE. The multiple transport blocks may include at least an initial transmission of a new transport block and/or retransmissions for any transport blocks from previous allocations that a receiver was not able to decode successfully.

### CROSS REFERENCES

The present Application is a 371 national stage filing of International PCT Application No. PCT/US2024/027961 by OVED et al. entitled “FRAMEWORK FOR MULTIPLE TRANSPORT BLOCK SCHEDULING,” filed May 6, 2024; and claims priority to Israel Patent Application No. 302882 by OVED et al., entitled “FRAMEWORK FOR MULTIPLE TRANSPORT BLOCK SCHEDULING,” filed May 11, 2023, each of which is assigned to the assignee hereof, and each of which is expressly incorporated by reference in its entirety herein.

### FIELD OF TECHNOLOGY

The following relates to wireless communications, including a framework for multiple transport block (TB) scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support framework for multiple transport block (TB) scheduling. A Multi Incremental Redundancy Scheme (MIRS) is a spectral efficiency (SPEF) adaptation scheme for finding an optimal or sufficient SPEF for transmission of one or multiple TBs.

A wireless communication system may support a MIRS along with a scheduling and signaling framework to allow for multiple TBs to be scheduled in a single downlink resource allocation. For example, a network entity may schedule a single resource allocation for the transmission of multiple TBs from the network to A user equipment (UE). The multiple TBs may include at least a first (e.g., initial) transmission of a new TB (or multiple new TBs) and/or retransmissions for any TBs from previous allocations that a receiver (e.g., a UE) was not able to decode successfully. In some cases, the transmission for each TB may include channel bits associated with the code block (CB) groups (CBGs) or CBs that were not successfully decoded by the UE.

For each scheduled TB, the network may indicate additional MIRS features (e.g., hybrid automatic repeat request (HARQ) parameters, coding parameters, CBGs/CBs bitmap, etc.). The available resources (e.g., for initial TB size determination) for the initial transmission, the partial allocation granularity (e.g., what part of the allocation is used for each TB), feedback granularity (e.g., ACK/NACK per CBG) or a combination thereof, may vary depending on MIRS parameters or scheduling parameters. For example, an initial transmission may use all of available resources in an allocation or a portion of the available resources in the allocation. The partial allocation granularity may use ⅛ of allocation size. The feedback granularity may be per TB, per CBG, or per CB. Additionally, the network may signal control fields (e.g., downlink control information (DCI) fields) common to all of the scheduled TBs once per allocation, which may reduce overhead.

A method for wireless communications at a UE is described. The method may include receiving a control signal indicating a first set of scheduling parameters for transmission of a first TB via a downlink resource allocation according to a MIRS and indicating a second set of scheduling parameters for transmission of a second TB via the downlink resource allocation according to the multi incremental redundancy scheme, the first TB different from the second TB, where the control signal indicates a first set of incremental redundancy parameters for transmission of the first TB according to the MIRS and indicates a second set of incremental redundancy parameters for transmission of the second TB according to the MIRS and monitoring, via the downlink resource allocation in accordance with the first and second sets of scheduling parameters, for the first and second TBs based on the first set of incremental redundancy parameters and the second set of incremental redundancy parameters.

An apparatus for wireless communications at a UE is described. The apparatus may include a processor, memory coupled with the processor, and instructions stored in the memory. The instructions may be executable by the processor to cause the apparatus to receive a control signal indicating a first set of scheduling parameters for transmission of a first TB via a downlink resource allocation according to a MIRS and indicating a second set of scheduling parameters for transmission of a second TB via the downlink resource allocation according to the multi incremental redundancy scheme, the first TB different from the second TB, where the control signal indicates a first set of incremental redundancy parameters for transmission of the first TB according to the MIRS and indicates a second set of incremental redundancy parameters for transmission of the second TB according to the MIRS and monitor, via the downlink resource allocation in accordance with the first and second sets of scheduling parameters, for the first and second TBs based on the first set of incremental redundancy parameters and the second set of incremental redundancy parameters.

Another apparatus for wireless communications at a UE is described. The apparatus may include means for receiving a control signal indicating a first set of scheduling parameters for transmission of a first TB via a downlink resource allocation according to a MIRS and indicating a second set of scheduling parameters for transmission of a second TB via the downlink resource allocation according to the multi incremental redundancy scheme, the first TB different from the second TB, where the control signal indicates a first set of incremental redundancy parameters for transmission of the first TB according to the MIRS and indicates a second set of incremental redundancy parameters for transmission of the second TB according to the MIRS and means for monitoring, via the downlink resource allocation in accordance with the first and second sets of scheduling parameters, for the first and second TBs based on the first set of incremental redundancy parameters and the second set of incremental redundancy parameters.

A non-transitory computer-readable medium storing code for wireless communications at a UE is described. The code may include instructions executable by a processor to receive a control signal indicating a first set of scheduling parameters for transmission of a first TB via a downlink resource allocation according to a MIRS and indicating a second set of scheduling parameters for transmission of a second TB via the downlink resource allocation according to the multi incremental redundancy scheme, the first TB different from the second TB, where the control signal indicates a first set of incremental redundancy parameters for transmission of the first TB according to the MIRS and indicates a second set of incremental redundancy parameters for transmission of the second TB according to the MIRS and monitor, via the downlink resource allocation in accordance with the first and second sets of scheduling parameters, for the first and second TBs based on the first set of incremental redundancy parameters and the second set of incremental redundancy parameters.

In some examples of the method, apparatuses, and non-transitory computer-readable medium described herein, receiving the control signal may include operations, features, means, or instructions for receiving the control signal indicating a set of channel bits associated with the first and second TBs, where each of the first and second TBs corresponds to one of an initial transmission of a TB or a retransmission of a previous TB.

In some examples of the method, apparatuses, and non-transitory computer-readable medium described herein, receiving the control signal may include operations, features, means, or instructions for receiving the control signal indicating the first and second sets of incremental redundancy parameters, where each of the first and second sets of incremental redundancy parameters includes one or more respective HARQ parameters for a respective TB of the first and second TBs, one or more respective coding parameters for the respective TB of the first and second TBs, or a combination thereof.

In some examples of the method, apparatuses, and non-transitory computer-readable medium described herein, receiving the control signal may include operations, features, means, or instructions for receiving, as part of the first and second sets of scheduling parameters, an indication of a first allocation size for the first TB and a second allocation size for the second TB, where the first and second allocation sizes may be indicated by a respective portion of an allocation granularity.

In some examples of the method, apparatuses, and non-transitory computer-readable medium described herein, receiving the control signal may include operations, features, means, or instructions for receiving an indication of a bitmap for one or more CBGs based on a feedback procedure for at least one of the first TB and the second TB being CBG based feedback.

In some examples of the method, apparatuses, and non-transitory computer-readable medium described herein, receiving the control signal may include operations, features, means, or instructions for receiving an indication of a bitmap for one or more CBs based on a feedback procedure for at least one of the first TB and the second TB being CB based feedback.

In some examples of the method, apparatuses, and non-transitory computer-readable medium described herein, receiving the control signal may include operations, features, means, or instructions for receiving, as part of the first and second sets of scheduling parameters, an indication of an initial TB size corresponding to one or more initial TBs, where the initial TB corresponds to an initial transmission of at least the first TB or the second TB, and where the initial TB size may be based on a total resource allocation of the downlink resource allocation.

In some examples of the method, apparatuses, and non-transitory computer-readable medium described herein, receiving the control signal may include operations, features, means, or instructions for receiving, as part of the first and second sets of scheduling parameters, an indication of an initial TB size corresponding to one or more initial TBs, where the initial TB corresponds to an initial transmission of at least the first TB or the second TB, and where the initial TB size may be based on a fraction of a total resource allocation of the downlink resource allocation.

In some examples of the method, apparatuses, and non-transitory computer-readable medium described herein, receiving the control signal may include operations, features, means, or instructions for receiving, as part of the first and second sets of scheduling parameters, a retransmission scheduling granularity for the first TB and the second TB.

In some examples of the method, apparatuses, and non-transitory computer-readable medium described herein, the retransmission scheduling granularity corresponds to one of a TB based retransmission scheduling granularity, a CB based retransmission scheduling granularity, or a CBG based retransmission scheduling granularity.

Some examples of the method, apparatuses, and non-transitory computer-readable medium described herein may further include operations, features, means, or instructions for receiving, as part of the first and second sets of scheduling parameters, a respective feedback granularity for each of the first TB and the second TB and transmitting a feedback message indicating feedback for at least one of the first TB and the second TB based on the monitoring, where the feedback message may be in accordance with the respective feedback granularity.

In some examples of the method, apparatuses, and non-transitory computer-readable medium described herein, receiving the control signal may include operations, features, means, or instructions for receiving an indication of whether the first set of incremental redundancy parameters or the second set of incremental redundancy parameters may be fixed or dynamic.

In some examples of the method, apparatuses, and non-transitory computer-readable medium described herein, the control signal includes one or more scheduling parameters common to both the first TB and the second TB and the first and second sets of scheduling parameters may be different.

A method for wireless communications at a network entity is described. The method may include transmitting a control signal indicating a first set of scheduling parameters for transmission of a first TB to a UE via a downlink resource allocation according to a MIRS and indicating a second set of scheduling parameters for transmission of a second TB to the UE via the downlink resource allocation according to the multi incremental redundancy scheme, the first TB different from the second TB, where the control signal indicates a first set of incremental redundancy parameters for transmission of the first TB according to the MIRS and indicates a second set of incremental redundancy parameters for transmission of the second TB according to the MIRS and transmitting, via the downlink resource allocation in accordance with the first and second sets of scheduling parameters, the first and second TBs based on the first set of incremental redundancy parameters and the second set of incremental redundancy parameters.

An apparatus for wireless communications at a network entity is described. The apparatus may include a processor, memory coupled with the processor, and instructions stored in the memory. The instructions may be executable by the processor to cause the apparatus to transmit a control signal indicating a first set of scheduling parameters for transmission of a first TB to a UE via a downlink resource allocation according to a MIRS and indicating a second set of scheduling parameters for transmission of a second TB to the UE via the downlink resource allocation according to the multi incremental redundancy scheme, the first TB different from the second TB, where the control signal indicates a first set of incremental redundancy parameters for transmission of the first TB according to the MIRS and indicates a second set of incremental redundancy parameters for transmission of the second TB according to the MIRS and transmit, via the downlink resource allocation in accordance with the first and second sets of scheduling parameters, the first and second TBs based on the first set of incremental redundancy parameters and the second set of incremental redundancy parameters.

Another apparatus for wireless communications at a network entity is described. The apparatus may include means for transmitting a control signal indicating a first set of scheduling parameters for transmission of a first TB to a UE via a downlink resource allocation according to a MIRS and indicating a second set of scheduling parameters for transmission of a second TB to the UE via the downlink resource allocation according to the multi incremental redundancy scheme, the first TB different from the second TB, where the control signal indicates a first set of incremental redundancy parameters for transmission of the first TB according to the MIRS and indicates a second set of incremental redundancy parameters for transmission of the second TB according to the MIRS and means for transmitting, via the downlink resource allocation in accordance with the first and second sets of scheduling parameters, the first and second TBs based on the first set of incremental redundancy parameters and the second set of incremental redundancy parameters.

A non-transitory computer-readable medium storing code for wireless communications at a network entity is described. The code may include instructions executable by a processor to transmit a control signal indicating a first set of scheduling parameters for transmission of a first TB to a UE via a downlink resource allocation according to a MIRS and indicating a second set of scheduling parameters for transmission of a second TB to the UE via the downlink resource allocation according to the multi incremental redundancy scheme, the first TB different from the second TB, where the control signal indicates a first set of incremental redundancy parameters for transmission of the first TB according to the MIRS and indicates a second set of incremental redundancy parameters for transmission of the second TB according to the MIRS and transmit, via the downlink resource allocation in accordance with the first and second sets of scheduling parameters, the first and second TBs based on the first set of incremental redundancy parameters and the second set of incremental redundancy parameters.

In some examples of the method, apparatuses, and non-transitory computer-readable medium described herein, transmitting the control signal may include operations, features, means, or instructions for transmitting the control signal indicating a set of channel bits associated with the first and second TBs, where each of the first and second TBs corresponds to one of an initial transmission of a TB or a retransmission of a previous TB.

In some examples of the method, apparatuses, and non-transitory computer-readable medium described herein, transmitting the control signal may include operations, features, means, or instructions for transmitting the control signal indicating the first and second sets of incremental redundancy parameters, where each of the first and second sets of incremental redundancy parameters includes one or more respective HARQ parameters for a respective TB of the first and second TBs, one or more respective coding parameters for the respective TB of the first and second TBs, or a combination thereof.

In some examples of the method, apparatuses, and non-transitory computer-readable medium described herein, transmitting the control signal may include operations, features, means, or instructions for transmitting, as part of the first and second sets of scheduling parameters, an indication of a first allocation size for the first TB and a second allocation size for the second TB, where the first and second allocation sizes may be indicated by a respective portion of an allocation granularity.

In some examples of the method, apparatuses, and non-transitory computer-readable medium described herein, transmitting the control signal may include operations, features, means, or instructions for transmitting an indication of a bitmap for one or more CBGs based on a feedback procedure for at least one of the first TB and the second TB being CBG based feedback.

In some examples of the method, apparatuses, and non-transitory computer-readable medium described herein, transmitting the control signal may include operations, features, means, or instructions for transmitting an indication of a bitmap for one or more CBs based on a feedback procedure for at least one of the first TB and the second TB being CB based feedback.

In some examples of the method, apparatuses, and non-transitory computer-readable medium described herein, transmitting the control signal may include operations, features, means, or instructions for transmitting, as part of the first and second sets of scheduling parameters, an indication of an initial TB size corresponding to one or more initial TBs, where the initial TB corresponds to an initial transmission of at least the first TB or the second TB, and where the initial TB size may be based on a total resource allocation of the downlink resource allocation.

In some examples of the method, apparatuses, and non-transitory computer-readable medium described herein, transmitting the control signal may include operations, features, means, or instructions for transmitting, as part of the first and second sets of scheduling parameters, an indication of an initial TB size corresponding to one or more initial TBs, where the initial TB corresponds to an initial transmission of at least the first TB or the second TB, and where the initial TB size may be based on a fraction of a total resource allocation of the downlink resource allocation.

In some examples of the method, apparatuses, and non-transitory computer-readable medium described herein, transmitting the control signal may include operations, features, means, or instructions for transmitting, as part of the first and second sets of scheduling parameters, a retransmission scheduling granularity for the first TB and the second TB.

In some examples of the method, apparatuses, and non-transitory computer-readable medium described herein, the retransmission scheduling granularity corresponds to one of a TB based retransmission scheduling granularity, a CB based retransmission scheduling granularity, or a CBG based retransmission scheduling granularity.

Some examples of the method, apparatuses, and non-transitory computer-readable medium described herein may further include operations, features, means, or instructions for transmitting, as part of the first and second sets of scheduling parameters, a respective feedback granularity for each of the first TB and the second TB and receiving, from the UE, a feedback message indicating feedback for at least one of the first TB and the second TB based on transmitting the first and second TBs, where the feedback message may be in accordance with the respective feedback granularity.

In some examples of the method, apparatuses, and non-transitory computer-readable medium described herein, transmitting the control signal may include operations, features, means, or instructions for transmitting an indication of whether the first set of incremental redundancy parameters or the second set of incremental redundancy parameters may be fixed or dynamic.

In some examples of the method, apparatuses, and non-transitory computer-readable medium described herein, the control signal includes one or more scheduling parameters common to both the first TB and the second TB and the first and second sets of scheduling parameters may be different.

### BRIEF DESCRIPTION OF THE DRAWINGS

FIG. 1 shows an example of a wireless communications system that supports framework for multiple transport block (TB) scheduling in accordance with one or more aspects of the present disclosure.

FIG. 2 shows an example of a wireless communications system that supports framework for multiple TB scheduling in accordance with one or more aspects of the present disclosure.

FIG. 3 shows an example of a downlink resource grid that supports framework for multiple TB scheduling in accordance with one or more aspects of the present disclosure.

FIG. 4 shows an example of a downlink resource grid that supports framework for multiple TB scheduling in accordance with one or more aspects of the present disclosure.

FIG. 5 shows an example of a downlink resource grid that supports framework for multiple TB scheduling in accordance with one or more aspects of the present disclosure.

FIG. 6 shows an example of a process flow that supports framework for multiple TB scheduling in accordance with one or more aspects of the present disclosure.

FIGS. 7 and 8 show block diagrams of devices that support framework for multiple TB scheduling in accordance with one or more aspects of the present disclosure.

FIG. 9 shows a block diagram of a communications manager that supports framework for multiple TB scheduling in accordance with one or more aspects of the present disclosure.

FIG. 10 shows a diagram of a system including a device that supports framework for multiple TB scheduling in accordance with one or more aspects of the present disclosure.

FIGS. 11 and 12 show block diagrams of devices that support framework for multiple TB scheduling in accordance with one or more aspects of the present disclosure.

FIG. 13 shows a block diagram of a communications manager that supports framework for multiple TB scheduling in accordance with one or more aspects of the present disclosure.

FIG. 14 shows a diagram of a system including a device that supports framework for multiple TB scheduling in accordance with one or more aspects of the present disclosure.

FIGS. 15 through 17 show flowcharts illustrating methods that support framework for multiple TB scheduling in accordance with one or more aspects of the present disclosure.

### DETAILED DESCRIPTION

Multi Incremental Redundancy Scheme (MIRS) is a spectral efficiency (SPEF) adaptation scheme that may be supported by a wireless communications to obtain, determine, or estimate an accurate, sufficient, or closer to optimal SPEF for transmission of a transport block (TB). In MIRS, a network may adjust a code rate, a modulation and coding scheme (MCS), or both. Traditionally (e.g., using current measurement-based link adaptation), a user equipment (UE) may measure reference signals and may send these measurements to a network. Using the measurements, the network may determine a SPEF for a transmission of a TB to the UE. In MIRS, the network may overestimate a SPEF for an initial transmission of a TB (e.g., if the SPEF is determined to be 4.5 bits per resource element (RE), the network may instead use an MCS corresponding to a SPEF of 6 bits per RE).

In an MIRS, each retransmission after an initial transmission of a TB may utilize a decreased (e.g., reduced) MCS (or equivalently reduce the effective SPEF) until the TB is successfully decoded at the UE, thus approaching the optimal SPEF (e.g., channel capacity) with each retransmission. As retransmissions may correspond to a smaller allocation of time and frequency resources compared to the initial transmission, each retransmission may involve less and less resources. However, because retransmissions may be utilized for the MIRS transmission scheme, the scheduling of only 1 TB per each allocation may lead to increased latency and, for some TBs, unacceptable latency.

A method for a scheduling and signaling framework to allow for multiple TBs to be scheduled in a single downlink resource allocation for transmissions that utilize MIRS is described. For example, a network may schedule a single resource allocation for the transmission of multiple TBs from the network to the UE. The multiple TBs may include at least a first (e.g., initial) transmission of a new TB (or multiple new TBs) and/or retransmissions for any TBs from previous allocations that a receiver (e.g., a UE) was not able to decode successfully. In some cases, the transmission for each TB may include channel bits associated with the code block (CB) groups (CBGs) or CBs that were not successfully decoded by the UE.

For each scheduled TB, the network may indicate additional MIRS features (e.g., hybrid automatic repeat request (HARQ) parameters, coding parameters, CBGs/CBs bitmap, etc.). Possible implementations may differ in the available resources (e.g., for initial TB size determination) for the initial transmission, the retransmission scheduling granularity (e.g., retransmission bits per failing TB/CB/CBG), or a combination thereof. For example, an initial transmission may use all of available resources in an allocation or a portion of the available resources in the allocation. The feedback granularity and retransmission granularity may be per TB, per CBG, or per CB. Additionally, the network may signal control fields (e.g., downlink control information (DCI) fields) common to all of the scheduled TBs once per allocation, which may reduce overhead, while DCI fields specific to each TB may be signaled once per TB. The UE may transmit a feedback message to the network indicating whether the UE was able to successfully decode the transmitted TBs or which CBs/CBGs it failed to decode according to the feedback granularity.

Aspects of the disclosure are initially described in the context of wireless communications systems. Additional aspects of this disclosure are described in the context of downlink resource grids and process flows. Aspects of the disclosure are further illustrated by and described with reference to apparatus diagrams, system diagrams, and flowcharts that relate to framework for multiple TB scheduling.

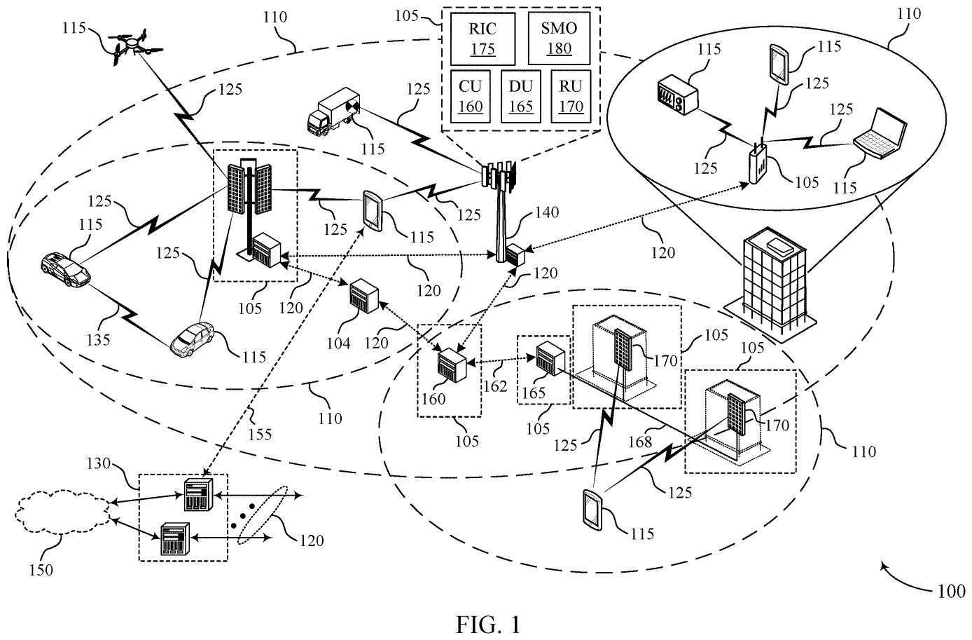

FIG. 1 shows an example of a wireless communications system 100 that supports framework for multiple TB scheduling in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support framework for multiple TB scheduling as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, an RE may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

MIRS is a SPEF adaptation scheme that may be utilized or support by wireless communications system 100. MIRS may be used by wireless devices (e.g., UEs 115, network entities 105) for obtaining higher throughput and more efficient utilization of network resources through the finding of a suitable, more accurate, or closer to optimal, SPEF for transmission of one or more TBs. Traditionally (e.g., using current measurement-based link adaptation), a UE 115 may measure reference signals and may send these measurements to a network entity 105. Using the measurements, the network entity 105 may determine a SPEF for a transmission of a TB to the UE 115. In MIRS, the network entity 105 may overestimate the SPEF for an initial transmission of a TB (e.g., if the SPEF is determined to be 4.5 bits per RE, the network may instead use an MCS corresponding to a SPEF of 6 bits per RE). The network entity 105 may transmit the initial transmission of the TB expecting the decoding of the TB to fail due to the overestimated SPEF (e.g., the UE 115 is not able to successfully decode the TB transmitted by the network entity 105).

In an MIRS, each retransmission after an initial transmission of a TB may reduce an effective SPEF. For example, after an initial transmission of a TB that used a full slot with an MCS-21 equivalent SPEF (e.g., 3.61), the retransmission may reduce the effective SPEF to an MCS-20 equivalent SPEF (e.g., 3.32) by adding approximately 0.09 of the slot with additional parity bits. This process of reducing the SPEF (e.g., using small size retransmission) may be repeated until the TB is successfully decoded at the UE 115, thus approaching the optimal SPEF with each retransmission. As retransmissions may correspond to a smaller allocation of time and frequency resources compared to the initial transmission, each retransmission may involve fewer and fewer resources. Further, the quantity of resources involved in the retransmission of a TB may decrease when using CBG retransmission granularity or CB retransmission granularity. However, scheduling a single transmission (e.g., TB) using a small quantity of resources (e.g., such as a CB or a CBG) may result in a large overhead, unallocated (e.g., unused) resources, and a complicated signaling framework. Also, because multiple retransmissions may be utilized for the MIRS transmission scheme, the scheduling of only 1 TB per each allocation may lead to increased latency and, for some TBs, unacceptable latency.

Wireless communications system 100 may support a scheduling and signaling framework to allow for multiple TBs to be scheduled in a single downlink resource allocation for transmissions that utilize MIRS. For example, a network entity 105 may schedule a single resource allocation for the transmission of multiple TBs from the network entity 105 to the UE 115. The multiple TBs may include at least an initial transmission of a new TB (or multiple new TBs) and/or retransmissions for any TBs from previous allocations that a receiver (e.g., the UE 115) was not able to decode successfully. The network entity 105 may allocate a different, or the same, quantity of resource for each respective TB in the same downlink resource allocation. In some cases, the retransmission for any TBs may include information for the CBGs or CBs that were not successfully decoded by the UE 115.

For each scheduled TB, the network entity 105 may indicate additional MIRS parameters (e.g., HARQ parameters, coding parameters, CBGs/CBs bitmap, etc.). Possible implementations may differ in the available resources (e.g., for initial TB size determination) for the initial transmission, the retransmission scheduling granularity (e.g., retransmission bits per failing TB/CB/CBG), or a combination thereof. For example, an initial transmission may use all of the available resources in an allocation or a portion of the available resources in the allocation. The retransmission granularity may be per TB, per CBG, or per CB. Additionally, the network entity 105 may transmit information (e.g., scheduling parameters) common to all scheduled TBs once per allocation (e.g., within a DCI, RRC, or MAC-CE), which may reduce overhead. Scheduling information or parameters specific to each TB may be signaled once per TB (e.g., via DCI, RRC, or MAC-CE). The UE 115 may transmit a feedback message to the network entity 105 indicating whether the UE 115 was able to successfully decode the transmitted TBs or CBs/CBGs within it.

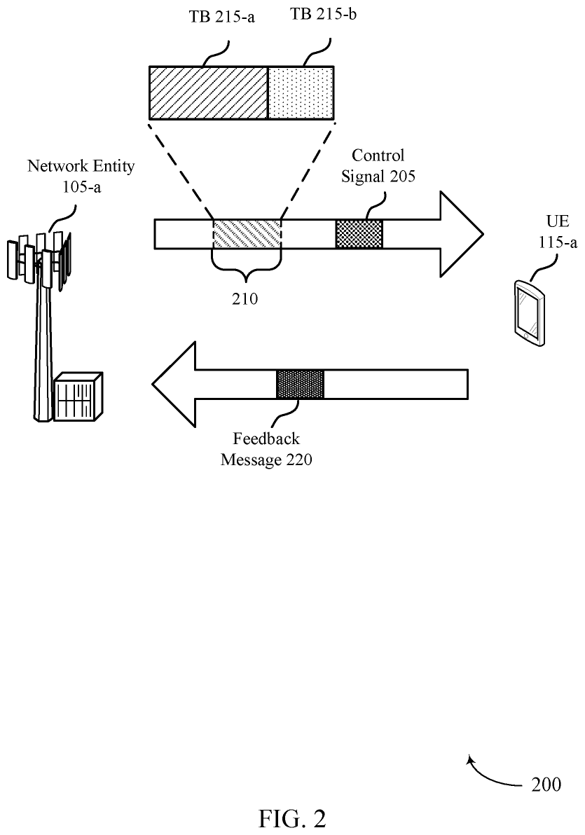

FIG. 2 shows an example of a wireless communications system 200 that supports framework for multiple TB scheduling in accordance with one or more aspects of the present disclosure. The wireless communications system 200 may implement aspects of the wireless communications system 100. For example, the wireless communications system 200 may include a network entity 105-a and a UE 115-a which may be examples of a network entity 105 and a UE 115, respectively, as described with reference to FIG. 1.

In some cases, the network entity 105-a and the UE 115-a may perform uplink and downlink transmissions. For example, the network entity 105-a may transmit a control signal 205 that schedules a downlink resource allocation 210 for transmission of one or more TBs 215 to the UE 115-a. In response, the UE 115-a may monitor for the one or more TBs 215 and transmit a feedback message 220 to the network entity 105-a indicating whether each of the one or more TBs 215 was successfully decoded. In some instances, multiple TBs 215 may be scheduled for transmission via a single downlink resource allocation 210. For instance, the downlink resource allocation 210 may be scheduled for transmission of a TB 215-a (e.g., a first TB) and a TB 215-b (e.g., a second TB).

In some instances, the network entity 105-a may transmit parameters for MIRS in the control signal 205 to the UE 115-a. For example, the control signal 205 may indicate scheduling parameters and incremental redundancy parameters for the transmission of the multiple TBs 215. The network entity 105-a may indicate these respective parameters for each scheduled TB 215. That is, the control signal 205 may indicate a first set of scheduling parameters and a first set of incremental redundancy parameters for the transmission of the TB 215-a. Similarly, the control signal 205 may indicate a second set of scheduling parameters and a second set of incremental redundancy parameters for the transmission of the TB 215-b. Although described as including the TB 215-a and the TB 215-b for illustrative purposes, the downlink resource allocation 210 may include any quantity of TBs 215 (e.g., two or more TBs).

The control signal 205 may schedule multiple TBs (e.g., the TB 215-a and the TB 215-b) for a single resource allocation (e.g., the downlink resource allocation 210). In some cases, the downlink resource allocation 210 may support multiple TBs 215. In some instances, the TB 215-a, the TB 215-b, or both, may be a first (e.g., initial) transmission of a new TB 215. That is, a TB 215 that the UE 115-a has not received or attempted to decode. In some other instances, the TB 215-a, the TB 215-b, or both, may be a retransmission of a previous TB 215 that was not decoded successfully by the UE 115-a.

In some cases, the network entity 105-a may indicate incremental redundancy parameters associated with the TBs 215 to the UE 115-a. That is, the control signal 205 may include fields (e.g., DCI fields) indicating MIRS parameters, which may be referred to as incremental redundancy parameters. For example, the incremental redundancy parameters may include HARQ parameters (e.g., a HARQ process number, a new data indicator) for the TB 215-a and the TB 215-b. The UE 115-a may transmit the feedback message 220 according to these HARQ parameters. Additionally, or alternatively, the incremental redundancy parameters may include coding parameters (e.g., an initial MCS, a redundancy version (RV) index, RV delta (dRV), RV size (sRV) values, or any combination thereof) for the TB 215-a and the TB 215-a. The coding parameters may support retransmissions (e.g., thin retransmissions) for a TB 215 that uses less resources than the original transmission of the TB 215. In some instances, the network entity 105-a may indicate whether the incremental redundancy parameters may be fixed or may be dynamically changed (e.g., updated) by the network entity 105-a.

In some cases, the network entity 105-a may indicate scheduling parameters associated with the TBs 215 to the UE 115-a. For example, the scheduling parameters may include allocation size information. The network entity 105-a may transmit the control signal 205 indicating an allocation size for the TB 215-a and an allocation size for the TB 215-b. In some instances, the network entity 105-a may indicate each allocation size with respect to (e.g., out of) a total allocation size (e.g., the downlink resource allocation 210).

In some cases, the network entity 105-a may indicate the allocation size (e.g., payload size) used to determine the TB size of TB 215-a. For example, the network entity 105-a may calculate the payload size (e.g., transport block size (TBS)) for the TB 215-a according to all of the available resources N_{RE}. In this example, the network entity 105-a may transmit one initial (e.g., new) TB 215 in the downlink resource allocation 210. That is, the network entity 105-a may indicate the payload size for the TB 215-a according to a quantity of resources in the downlink resource allocation 210.

In another example, the network entity 105-a may calculate the payload size for the TB 215-a based on allocated size of a portion (e.g., fraction) of the available resources

$$\frac{{N}_{RE}}{{N}_{TB}} .$$

In this example, the network entity may transmit multiple initial TBs 215 in the downlink resource allocation 210. That is, the network entity 105-a may indicate the allocation size for determining the payload size for TB 215-a according to the quantity of resources in the downlink resource allocation 210 divided by the quantity of new TBs 215 N_{TB} that may be scheduled on the downlink resource allocation 210. In some instances, the network entity 105-a may assume that each new TB 215-a payload size is based on allocating the same quantity of resources (e.g., equal size).

In some cases, the network entity 105-a may transmit the control signal 205 indicating a bitmap to the UE 115-a. The bitmap may indicate which information is included in the received allocation. For example, the control signal 205 may include a bitmap for one or more CBGs (e.g., a CBGs bitmap) and a bitmap for one or more CBs (e.g., a CBs bitmap) indicating which CBGs or CBs have additional information in the received allocation. In some instances, the UE 115-a may receive the CBGs bitmap based on the feedback procedure for the TB 215-a or the TB 215-b being for CBGs. That is, the UE 115-a may receive the CBGs bitmap when the UE 115-a is configured with CBG feedback (e.g., the UE 115-a is configured to transmit a feedback message 220 per CBG allocation). In some other or the same instances, the UE 115-a may receive the CBs bitmap based on the feedback procedure for the TB 215-a or the TB 215-b being for CBs. That is, the UE 115-a may receive the CBs bitmap when the UE 115-a is configured with CB feedback (e.g., the UE 115-a is configured to transmit a feedback message 220 per CB allocation.

In some cases, the network entity 105 may transmit the control signal 205 to the UE 115-a indicating the allocated resources associated with the TB 215-a and the TB 215-b based on a retransmission granularity (e.g., retransmission scheduling granularity). The retransmission granularity may indicate information that is included in the downlink resource allocation 210 (e.g., such as a quantity of TBs 215 included per allocation). For example, the UE 115-a may receive a retransmission granularity for the TB 215-a and the TB 215-b. The retransmission granularity may be the same for each TB 215 associated with a retransmission of a previous TB 215. In some instances, the control signal 205 may indicate that the retransmission granularity may be per TB 215, per CBG, or per CB. For instance, the network entity may transmit a control information based on the retransmission granularity indicating a quantity of retransmission bits per failing (e.g., the UE 115-a is not able to successfully decode the transmission) TB 215-a, per CBG, or per CB.

Additional details of possible options for scheduling the TBs 215 in the downlink resource allocation 210 are illustrated by Table 1, shown below.

TABLE 1
Options for TB Scheduling in a Single Allocation

| | Available Resources for 1st | Retransmission |
|---|---|---|
| Option | Transmission TB Size Calculation | Granularity |
| 1 | All available resources N_{RE} | Per TB |
| 2 | All available resources N_{RE} | Per CB or Per |
| | | CBG |
| 3 | $A fraction of available resources \frac{{N}_{R E}}{{N}_{T B}}$ | Per TB |

In Table 1, the available resources for an initial transmission of a TBs 215 may be calculated according to all of the available resources N_{RE} or a portion of the available resources

$$\frac{{N}_{R E}}{{N}_{T B}} .$$

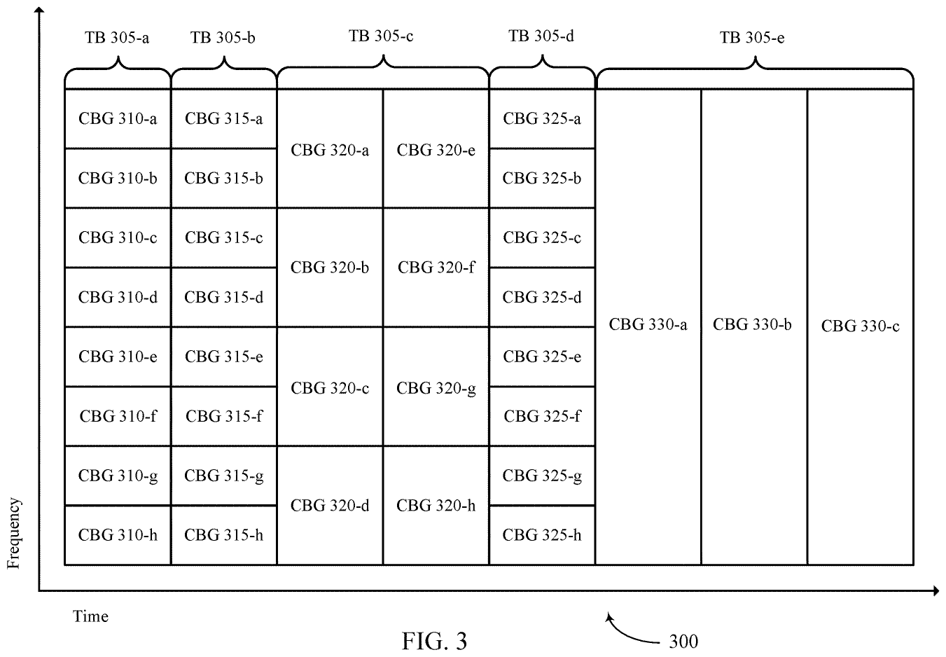

The retransmission granularity may be per each TB 215, per each CB, or per each CBG. For example, a first embodiment may include an allocation size for an initial TB 215 calculated according to the quantity of resources in the downlink resources allocation 210 and a retransmission granularity per each TB 215. A second embodiment may include an allocation size for the initial TB 215 calculated according to the quantity of resources in the downlink resources allocation 210 and a retransmission granularity per each CB or per each CBG. A third embodiment may include an allocation size for the initial TB 215 calculated according to the quantity of resources in the downlink resource allocation 210 divided by the quantity of new TBs 215 and a retransmission granularity per each TB 215. These embodiments may be described in further detail with regard to FIGS. 3-5.

FIG. 3 shows an example of a downlink resource grid 300 that illustrates resources for multiple TB scheduling in accordance with one or more aspects of the present disclosure. The downlink resource grid 300 may implement aspects of the wireless communications system 100 and the wireless communications system 200. For example, the downlink resource grid 300 may represent the resources associated with a downlink resource allocation, which may be an example of the downlink resource allocation 210 as described with reference to FIG. 2.

In some cases, the downlink resource grid 300 may include time-frequency resources. For example, one or more downlink resources may be combined to form one or more TBs 305. Similarly, one or more downlink resources may be combined to form one or more CBGs within the TBs 305.

In some cases, the downlink resource grid 300 may represent the resources included in a downlink resource allocation. For example, the downlink resource grid 300 may depict an example of Option 1, as shown in Table 1. In Option 1, a network entity may calculate and indicate the respective allocation sizes for the TBs 305 according to all of the available resources N_{RE} in a full allocation. Additionally, the network entity may indicate that the retransmission granularity for the allocation is per TB 305.

In some cases, a downlink resource allocation may contain multiple TBs 305, and each TB 305 may contain multiple CBGs. In the example of FIG. 3, the downlink resource grid 300 may contain 5 TBs 305 (e.g., a TB 305-a, a TB 305-b, a TB 305-c, a TB 305-d, and a TB 305-e). Further, in the example of FIG. 3, each TB 305 may contain 8 CBGs. For instance, the TB 305-a may include a CBG 310-a, a CBG 310-b, a CBG 310-c, a CBG 310-d, a CBG 310-e, a CBG 310-f, a CBG 310-g, and a CBG 310-h. The TB 305-b may include a CBG 315-a, a CBG 315-b, a CBG 315-c, a CBG 315-d, a CBG 315-e, a CBG 315-f, a CBG 315-g, and a CBG 315-h. The TB 305-c may include a CBG 320-a, a CBG 320-b, a CBG 320-c, a CBG 320-d, a CBG 320-e, a CBG 320-f, a CBG 320-g, and a CBG 320-h. The TB 305-d may include a CBG 325-a, a CBG 325-b, a CBG 325-c, a CBG 325-d, a CBG 325-e, a CBG 325-f, a CBG 325-g, and a CBG 325-h. The TB 305-e may include a CBG 330-a, a CBG 330-b, and a CBG 330-c. Each TB 305 may be in a different stage of retransmission.

In some cases, the network entity may allocate each TB 305 a portion of the total allocation (e.g., a portion of the resources in the downlink resource grid 300). For an initial transmission of a respective TB 305, the network entity may set the allocation size for the respective TBs 305 according to the quantity (e.g., total number) of resources in the allocation. In the example of FIG. 3, the partial allocation granularity may be ⅛. For example, the network entity may allocate the TB 305-a⅛ of the total size of the downlink resource grid 300 (e.g., of a downlink resource allocation).

Additionally, the network entity may allocate ⅛ of the total allocation to the TB 305-b, 2/8 of the total allocation to the TB 305-c, ⅛ of the total allocation to the TB 305-d, and ⅜ of the total allocation to the TB 305-e.

In some cases, one or more TBs 305 may be a retransmission of a previous TB 305. For any subsequent retransmissions of the respective TB 305, the network entity may divide a downlink resource allocation among the respective TBs 305 being retransmitted. For example, the network entity may calculate and indicate the allocation size of respective TBs 305 according to the number of respective TBs 305 in the downlink resource allocation. That is, the network entity may divide an allocation for subsequent retransmissions of a TB 305 into

$$\frac{{N}_{R E}}{{N}_{g r a n}}$$

portions, where N_{gram} is a granularity of a partial allocation. A typical granularity may be a total quantity of TBs 305 in an allocation. In the example of FIG. 3, the TB 305-a, the TB 305-b, the TB 305-c, and the TB 305-d may each be retransmissions of respective TBs 305 that a UE previously failed to successfully decode. Each retransmitted TB 305 may correspond to an RV number indicating which retransmission (e.g., how many previous retransmissions have been transmitted for the respective TB 305) is included. In some instances, each retransmission may include incremental redundancy (IR) bits for each of the CBGs within the respective TB 305.

In some cases, the downlink resource allocation may include an initial transmission of a TB 305. In the example of FIG. 3, the TB 305-e may be an initial (e.g., new) transmission. The network entity may calculate a payload size for the TB 305-e based on the total quantity of available resources in the downlink resource allocation. Further, the network entity may allocate a portion of the available resources in the downlink resource allocation to the TB 305-e. The portion of the available resources may be the resources in the downlink resource allocation that are not occupied (e.g., allocated) by TBs 305 corresponding to a retransmission (e.g., the retransmission of a previous TB 305). For example, the TB 305-e may occupy the ⅜ of the downlink resource grid 300 that is not allocated to TBs 305 corresponding to a retransmission. Thus, the network entity may transmit the first three CBGs 330 corresponding to the TB 305-e (e.g., ⅜ of the CBGs corresponding to the TB 305-e). The network entity may transmit the following five CBGs 330 (e.g., ⅝ of the CBGs corresponding to the TB 305-e) via the next scheduled allocation (e.g., subsequent downlink resource allocation). That is, the network entity may transmit a portion of the TB 305-e in the downlink resource allocation and a different portion of the TB 305-e (e.g., the rest of the TB 305-e) in a future allocation. In some other cases, the network entity may indicate that the feedback and allocation size may correspond to all of the CBGs 330 (e.g., the whole TB 305-e).

In some cases, the network entity may signal (e.g., transmit) control fields (e.g., DCI fields) to the UE. For example, the network entity may signal the DCI fields that are common for each of the TBs 305 once per downlink resource allocation. For instance, the network entity may signal frequency division (FD) and time division (TD) resource allocations, a virtual resource block (VRB) to physical resource block (PRB) mapping, a transmit power control (TPC), or any combination thereof, once per allocation.

In some cases, the network entity may signal the DCI fields that are specific to each TB 305 once per each TB 305. For example, TB 305 specific DCI fields may include HARQ parameters (e.g., HARQ process, new data indicator), an initial MCS, a length of partially allocated resources, an indication of the initial bits for each CB in a respective TB 305, or any combination thereof. The network entity may signal the length of the partially allocated resources through an indication of the length in

$$\frac{{N}_{R E}}{{N}_{g r a n}}$$

portions, through incremental relative dRV (e.g., an index for predefined steps corresponding to the rate delta between respective MCS rates), or through a sRV which indicates that the step size has increased with each retransmission. The network entity may signal the initial bits for each CB in a respective TB 305 through an RV number (e.g., corresponding to a fixed location in a buffer) or by the end of a previous retransmission of the respective TB 305 ((e.g., implicitly indicated).

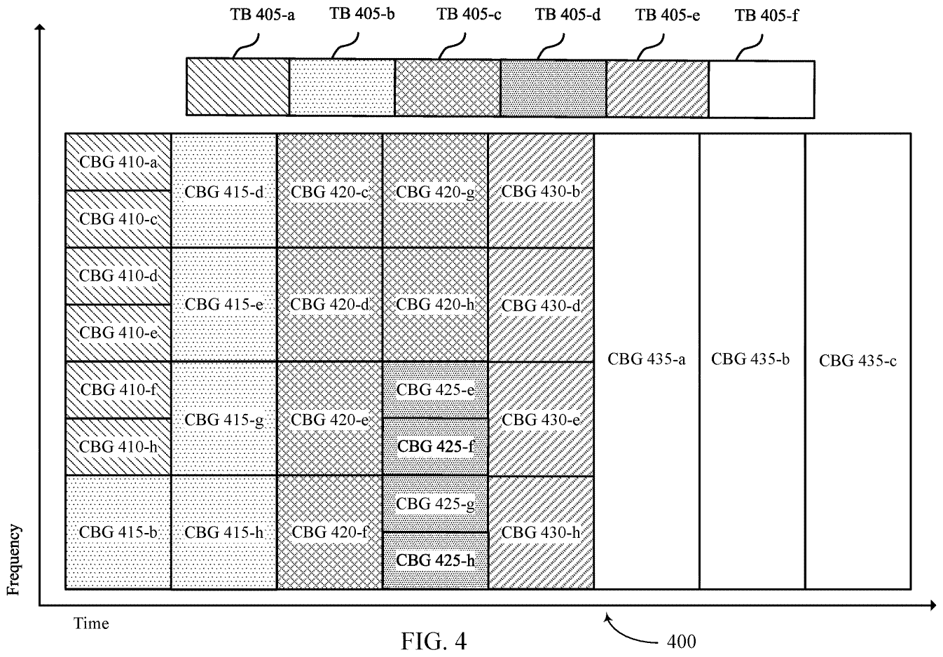

FIG. 4 shows an example of a downlink resource grid 400 that illustrates resources for multiple TB scheduling in accordance with one or more aspects of the present disclosure. The downlink resource grid 400 may implement aspects of the wireless communications system 100 and the wireless communications system 200. For example, the downlink resource grid 400 may represent the resources associated with a downlink resource allocation, which may be an example of the downlink resource allocation 210 as described with reference to FIG. 2.

In some cases, the downlink resource grid 400 may include time-frequency resources. For example, one or more downlink resources may combine to form one or more TBs 405. Similarly, one or more downlink resources may combine to form one or more CBGs within the TBs 405.

In some cases, the downlink resource grid 400 may represent the resources included in a downlink resource allocation. For example, the downlink resource grid 400 may depict an example of Option 2, as shown in Table 1. In Option 2, a network entity may calculate and indicate the respective allocation sizes for the TBs 405 according to all of the available resources N_{RE} in an allocation. Additionally, the network entity may indicate that the retransmission granularity for the allocation is per CBG.

In some cases, a downlink resource allocation may contain multiple TBs 405, and each TB 405 may contain multiple CBGs. In the example of FIG. 4, the downlink resource grid 400 may contain 6 TBs 405 (e.g., a TB 405-a, a TB 405-b, a TB 405-c, a TB 405-d, a TB 405-e, and a TB 405-f). Further, in the example of FIG. 4, each TB 405 may contain 8 CBGs. For instance, the TB 405-a may include a CBG 410-a, a CBG 410-c, a CBG 410-d, a CBG 410-e, a CBG 410-f, and a CBG 410-h. The TB 405-b may include a CBG 415-b, a CBG 415-d, a CBG 415-e, a CBG 415-g, and a CBG 415-h. The TB 405-c may include a CBG 420-c, a CBG 420-d, a CBG 420-e, a CBG 420-f, a CBG 420-g, and a CBG 420-h. The TB 305-d may include a CBG 425-e, a CBG 425-f, a CBG 425-g, and a CBG 425-h. The TB 405-e may include a CBG 430-b, a CBG 430-d, a CBG 430-e, and a CBG 430-h. The TB 405-f may include a CBG 435-a, a CBG 435-b, and a CBG 435-c. Each TB 405 may be in a different stage of retransmission.

In some cases, the network entity may allocate each TB 405 a portion of the total allocation (e.g., a portion of the resources in the downlink resource grid 400). For an initial transmission of a respective TB 405, the network entity may set the allocation size for the respective TBs 405 according to the quantity (e.g., total number) of resources in the allocation. In the example of FIG. 3, the partial allocation granularity may be

$$\frac{1}{64} .$$

For example, the network entity may allocate the TB 405-a

$$\frac{6}{64}$$

of the total size of the downlink resource grid 400 (e.g., downlink resource allocation). Additionally, the network entity may allocate

$$\frac{10}{64}$$

of the total allocation to the TB 405-b,

$$\frac{12}{64}$$

of the total allocation to the TB 405-c

$$\frac{4}{64}$$

of the total allocation to the TB 405-d,

$$\frac{8}{64}$$

of the total allocation to the TB 405-e, and

$$\frac{24}{64}$$

of the total allocation to the TB 405-f.

In some cases, one or more TBs 405 may be a retransmission of a previous TB 405. For any subsequent retransmissions of the respective TBs 405, the network entity may divide a downlink resource allocation among the respective TBs 405 being retransmitted. For example, the network entity may calculate and indicate the allocation size of respective TBs 405 according to the quantity of respective TBs 405 in the downlink resource allocation. That is, the network entity may divide an allocation for subsequent retransmissions of a TB 405 into

$$\frac{{N}_{R E}}{{N}_{g r a n}}$$

portions, where N_{gran} is a granularity of a partial allocation. A typical granularity may be a total quantity of TBs 405 in an allocation times the quantity of CBGs in a TB 405. For instance, the downlink resource allocation may include 8 TBs 405, where each TB 405 may have 8 CBGs. Thus, a typical N_{gran} may be 64.

In the example of FIG. 4, the TB 405-a, the TB 405-b, the TB 405-c, and the TB 405-d may each be retransmissions of respective TBs 405 that a UE previously failed to successfully decode. The network entity may only schedule and transmit feedback information for CBGs that have not been successfully decoded by the UE (e.g., failed CBGs). In some instances, each retransmission may include IR bits for each of the failed CBGs within each respective TB 405. In the example of FIG. 4. the TB 405-b may contain IR bits for the CBG 415-b, the CBG 415-d, the CBG 415-e, the CBG 415-g, and the CBG 415-h.

In some cases, the downlink resource allocation may include an initial transmission of a TB 405. In the example of FIG. 4, the TB 405-f may be an initial (e.g., new) transmission. The network entity may calculate a payload size for the TB 405-f based on the total quantity of available resources in the downlink resource allocation. Further, the network entity may allocate a portion of the available resources in the downlink resource allocation to the TB 405-f. The portion of the available resources may be the resources in the downlink resource allocation that are not occupied by TBs 405 corresponding to a retransmission. For example, the TB 405-f may occupy the

$$\frac{24}{64}$$

of the downlink resource grid 400 that is not allocated to TBs 405 corresponding to a retransmission. Thus, the network entity may transmit the first three CBGs 435 corresponding to the TB 405-f (e.g., ⅜ of the CBGs corresponding to the TB 405-f). The network entity may transmit the following five CBGs 435 (e.g., ⅝ of the CBGs corresponding to the TB 405-f) via the next scheduled allocation (e.g., subsequent downlink resource allocation). That is, the network entity may transmit a portion of the TB 405-f in the downlink resource allocation and a different portion of the TB 405-f (e.g., the rest of the TB 405-f) in a future allocation.

In some cases, the network entity may signal control fields (e.g., DCI fields) to the UE. For example, the network entity may signal DCI fields that are common for each of the TBs 405 once per downlink resource allocation. For instance, the network entity may signal FD/TD resource allocations, a VRB-to PRB mapping, a TPC, or any combination thereof, once per allocation.

In some cases, the network entity may signal DCI fields that are specific to each TB 405 once per each TB 405. The TB 405 specific DCI fields may include HARQ parameters, an initial MCS, a length of partially allocated resources, an indication of the initial bits for each CB in a respective TB 405, a bitmap of the CBGs included in the downlink resource allocation, or any combination thereof. In some instances, if the CBGs bitmap is not received by the UE, the network may transmit a compressed feedback signal (e.g., including a compressed CBGs bitmap).

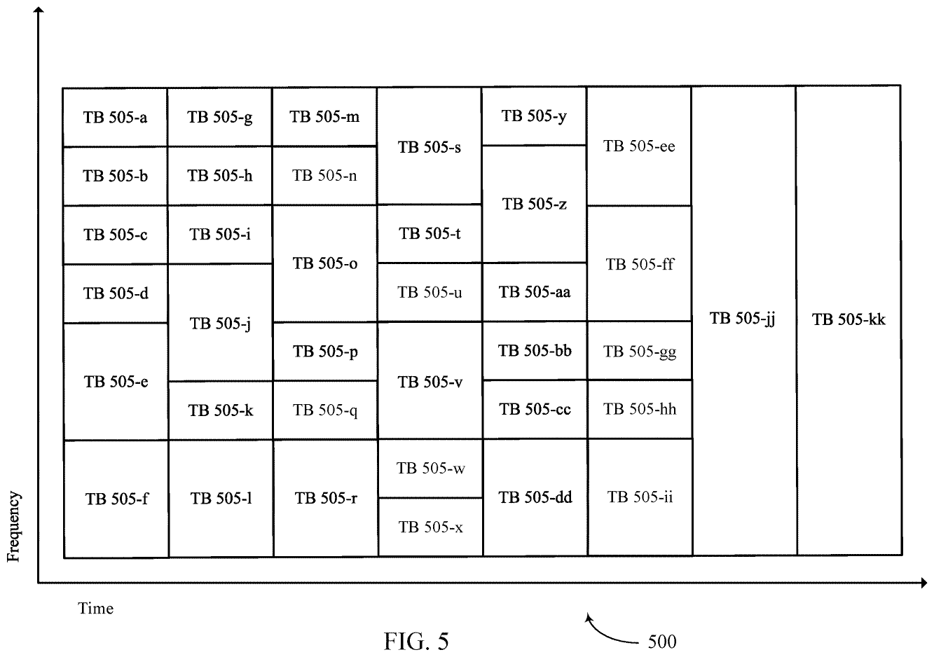

FIG. 5 shows an example of a downlink resource grid 500 that illustrates resources for multiple TB scheduling in accordance with one or more aspects of the present disclosure. The downlink resource grid 500 may implement aspects of the wireless communications system 100 and the wireless communications system 200. For example, the downlink resource grid 500 may represent the resources associated with a downlink resource allocation, which may be an example of the downlink resource allocation 210 as described with reference to FIG. 2.

In some cases, the downlink resource grid 500 may include time-frequency resources. For example, one or more downlink resources may combine to form one or more TBs 505.

In some cases, the downlink resource grid 500 may represent the resources included in a downlink resource allocation. For example, the downlink resource grid 500 may depict an example of Option 3, as shown in Table 1. In Option 3, a network entity may calculate and indicate the respective allocation sizes for the TBs 505 according to a fraction of the available resources

$$\frac{{N}_{R E}}{{N}_{T B}}$$

in an allocation, where N_{TB} is the quantity (e.g., maximum number) of initial TBs 505 in the allocation. Additionally, the network entity may indicate that the retransmission granularity for of the allocation is per TB 505 (e.g., the whole TB 505).

In some cases, a downlink resource allocation may contain multiple TBs 505. In the example of FIG. 5, the downlink resource grid 500 may contain 37 TBs 505 For example, the downlink resource grid 500 may include a TB 505-a, a TB 505-b, a TB 505-c, a TB 505-d, a TB 505-e, a TB 505-f, a TB 505-g, a TB 505-h, a TB 505-i, a TB 505-j, a TB 505-k, a TB 505-l, a TB 505-m, a TB 505-n, a TB 505-o, a TB 505-p, a TB 505-q, a TB 505-r, a TB 505-s, a TB 505-t, a TB 505-u, a TB 505-v, a TB 505-w, a TB 505-x, a TB 505-y, a TB 505-z, a TB 505-aa, a TB 505-bb, a TB 505-cc, a TB 505-dd, a TB 505-ee, a TB 505-ff, a TB 505-gg, a TB 505-hh, a TB 505-ii, a TB 505-jj, and a TB 505-kk. Each TB 505 may be in a different stage of retransmission and may have differencing allocation sizes.

In some cases, the network entity may allocate each TB 505 a portion of the available allocation (e.g., a portion of the resources in the downlink resource grid 500). For an initial transmission of a respective TB 505, the network entity may set the allocation size for the respective TB 505 according to the quantity of available resources in the allocation per the quantity of initial TBs in the allocation. In the example of FIG. 5, the partial allocation granularity may be

$$\frac{1}{64} .$$

For example the network entity may allocate the TB 505-a

$$\frac{1}{64}$$

of the total size of the downlink resource grid 500 (e.g., of a downlink resource allocation) and allocate

$$\frac{2}{64}$$

of the total allocation to the TB 505-e.

In some cases, one or more TBs 505 may be a retransmission of a previous TB 505. For any subsequent retransmissions of the respective TB 505, the network entity may divide a downlink resource allocation among the respective TBs 505 being retransmitted. For example, the network entity may calculate and indicate the allocation size of respective TBs 505 according to the number of respective TBs 505 in the downlink resource allocation. That is, the network entity may divide an allocation for subsequent retransmission of TBs 505 into

$$\frac{{N}_{R E}}{{N}_{g r a n}}$$

portions, where N_{gran} is the granularity of a partial allocation. A typical granularity may be a total quantity of TBs 505 in an allocation. For instance, the downlink resource allocation may include up to 8 TBs 505 corresponding to an initial transmission, where each initial TB 505 occupies ⅛ of the downlink resource allocation. Thus, a typical N_{gran} may be 64.

In the example of FIG. 5, the TB 505-a, through the TB 505-ii may each be retransmissions of respective TBs 505 that a UE previously failed to successfully decode. Each retransmitted TB 505 may correspond to an RV number indicating which retransmission (e.g., how many previous retransmissions have been transmitted for the respective TB 505) it is associated with. In some instances, each retransmission may include IR bits for each TB 505.

In some cases, the downlink resource allocation may include an initial transmission of a TB 505. In the example of FIG. 5, the TB 505-jj and the TB 505-kk may each be an initial transmission. Each respective initial transmission of a TB 505 may have a payload size (e.g., TBS) calculated according to an allocated resource size of ⅛ of the available resources in the downlink resource grid 500. For instance, the network entity may allocate a portion of the available resources in the downlink resource allocation to the TB 505-jj and the TB 505-kk. The portion of the available resources may be the resources in the downlink resource allocation that are not occupied by the TBs 505 corresponding to a retransmission. For example, 2/8 of the downlink resource grid 500 (e.g., total allocation) may be available. Thus, 2 new TBs may be sent (e.g., the TB 505-jj and the TB 505-kk) where each TB may occupy ⅛ of the downlink resource grid 500.

In some cases, the network entity may signal control fields to the UE. For example, the network entity may signal the DCI fields that are common for each of the TBs 505 once per downlink resource allocation. For instance, the network entity may signal FD/TD resource allocations, a VRB-to PRB mapping, a TPC, or any combination thereof, once per allocation.

In some cases, the network entity may signal the DCI fields that are specific to each TB 505 once per each TB 505. The TB 505 specific DCI fields may include HARQ parameters, an initial MCS, a length of partially allocated resources, an indication of the initial bits for each CB in a respective TB 505, or any combination thereof.

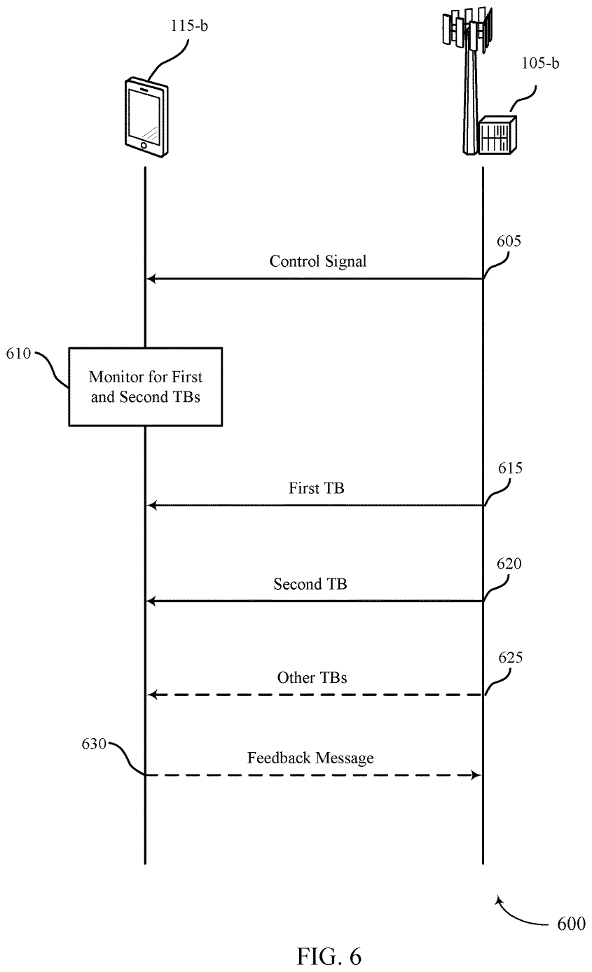

FIG. 6 shows an example of a process flow 600 that supports framework for multiple TB scheduling in accordance with one or more aspects of the present disclosure. The process flow 600 may implement aspects of the wireless communications system 100, the wireless communications system 200, the downlink resource grid 300, the downlink resource grid 400, and the downlink resource grid 500 described with reference to FIGS. 1 through 5. The process flow 600 may be based on communication between a UE 115-b and a network entity 105-b, which may be examples of the UE 115-a and the network entity 105-a, respectively, as described with reference to FIG. 2. The process flow 600 may be implemented by the UE 115-b and the network entity 105-b to decrease latency and improve transmission efficiency associated with allocating multiple TBs in an allocation. among other benefits.

In the following description of the process flow 600, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 600, and other operations may be added to the process flow 600.

At 605, the network entity 105-b may transmit a control signal to the UE 115-b. For example, the control signal may indicate scheduling parameters (e.g., partial allocation granularity) and incremental redundancy parameters associated with multiple TBs (e.g., a first TB and a second TB). In some cases, the control signal may indicate the scheduling parameters and the incremental redundancy parameters for a transmission of the multiple TBs via a downlink resource allocation (e.g., single allocation) according to a MIRS. Additionally, or alternatively, the control signal may indicate retransmission information (e.g., retransmission granularity) based on a feedback procedure.

At 610, the UE 115-b may monitor for the first TB and the second TB. For example, the UE 115-b may monitor for the first and second TBs via the downlink resource allocation according to the received scheduling parameters.

At 615, the network entity 105-b may transmit the first TB via the downlink resource allocation to the UE 115-b. In some cases, the first TB may correspond to an initial transmission of a TB or a retransmission of a previous TB. The UE 115-b may attempt to decode the first TB.

At 620, the network entity 105-b may transmit the second TB via the downlink resource allocation to the UE 115-b. In some cases, the second TB may correspond to an initial transmission of a TB or a retransmission of a previous TB. The UE 115-b may attempt to decode the second TB.

At 625, the network entity 105-b may transmit one or more other TBs (e.g., a third TB, a fourth TB, etc.) via the downlink resource allocation to the UE 115-b. In some cases, one or more of the other TBs may correspond to an initial transmission of a TB or a retransmission of a previous TB. The UE 115-b may attempt to decode the other TBs.

At 630, the UE 115-b may transmit a feedback message to the network entity 105-b. In some cases, the UE 115-b may transmit the feedback message according to the indicated feedback procedure (e.g., feedback granularity). For example, the feedback procedure for each respective TB may be TB, CBG, or CB based feedback. The feedback message may provide feedback for any of the multiple TBs (e.g., the transmitted first, second, or other TBs), the CBGs, or the CBs included in the downlink resource allocation. The feedback message may indicate whether the UE 115-b was able to successfully decode each respective TB.

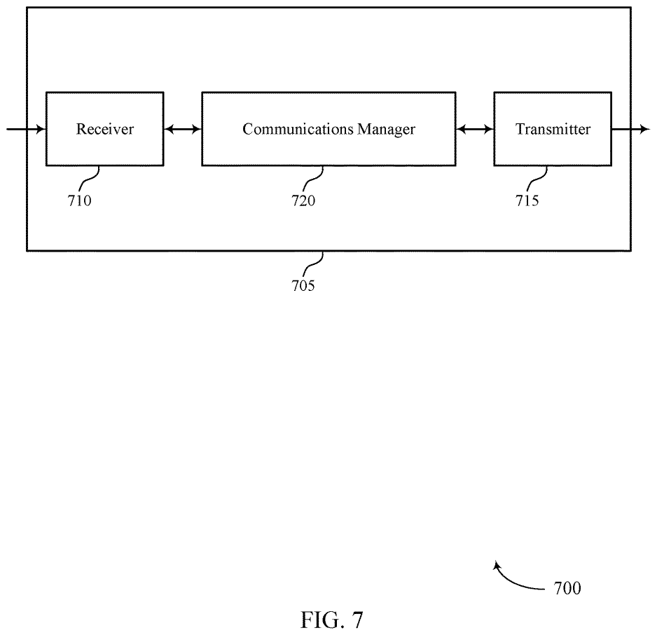

FIG. 7 shows a block diagram 700 of a device 705 that supports framework for multiple TB scheduling in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to framework for multiple TB scheduling). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to framework for multiple TB scheduling). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of framework for multiple TB scheduling as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 is capable of, configured to, or operable to support a means for receiving a control signal indicating a first set of scheduling parameters for transmission of a first TB via a downlink resource allocation according to a MIRS and indicating a second set of scheduling parameters for transmission of a second TB via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The communications manager 720 is capable of, configured to, or operable to support a means for monitoring, via the downlink resource allocation in accordance with the first and second sets of scheduling parameters, for the first and second TBs based on the first set of incremental redundancy parameters and the second set of incremental redundancy parameters.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources and higher throughput.

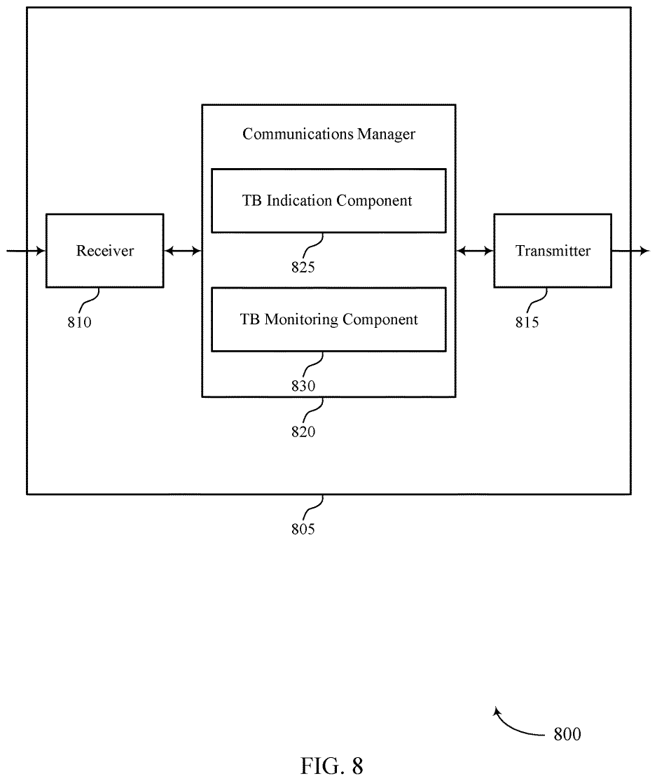

FIG. 8 shows a block diagram 800 of a device 805 that supports framework for multiple TB scheduling in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to framework for multiple TB scheduling). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to framework for multiple TB scheduling). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of framework for multiple TB scheduling as described herein. For example, the communications manager 820 may include a TB Indication Component 825 a TB Monitoring Component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The TB Indication Component 825 is capable of, configured to, or operable to support a means for receiving a control signal indicating a first set of scheduling parameters for transmission of a first TB via a downlink resource allocation according to a MIRS and indicating a second set of scheduling parameters for transmission of a second TB via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The TB Monitoring Component 830 is capable of, configured to, or operable to support a means for monitoring, via the downlink resource allocation in accordance with the first and second sets of scheduling parameters, for the first and second TBs based on the first set of incremental redundancy parameters and the second set of incremental redundancy parameters.

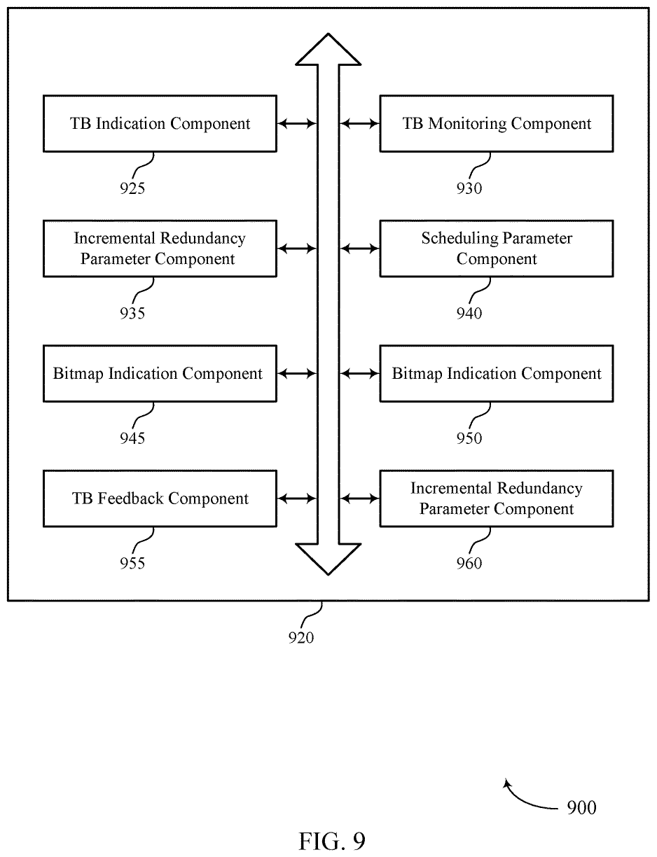

FIG. 9 shows a block diagram 900 of a communications manager 920 that supports framework for multiple TB scheduling in accordance with one or more aspects of the present disclosure. The communications manager 920 may be an example of aspects of a communications manager 720, a communications manager 820, or both, as described herein. The communications manager 920, or various components thereof, may be an example of means for performing various aspects of framework for multiple TB scheduling as described herein. For example, the communications manager 920 may include a TB Indication Component 925, a TB Monitoring Component 930, an Incremental Redundancy Parameter Component 935, a Scheduling Parameter Component 940, a Bitmap Indication Component 945, a Bitmap Indication Component 950, a TB Feedback Component 955, an Incremental Redundancy Parameter Component 960, or any combination thereof. Each of these components may communicate, directly or indirectly, with one another (e.g., via one or more buses).

The communications manager 920 may support wireless communications at a UE in accordance with examples as disclosed herein. The TB Indication Component 925 is capable of, configured to, or operable to support a means for receiving a control signal indicating a first set of scheduling parameters for transmission of a first TB via a downlink resource allocation according to a MIRS and indicating a second set of scheduling parameters for transmission of a second TB via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The TB Monitoring Component 930 is capable of, configured to, or operable to support a means for monitoring, via the downlink resource allocation in accordance with the first and second sets of scheduling parameters, for the first and second TBs based on the first set of incremental redundancy parameters and the second set of incremental redundancy parameters.

In some examples, to support receiving the control signal, the TB Indication Component 925 is capable of, configured to, or operable to support a means for receiving the control signal indicating a set of channel bits associated with the first and second TBs, where each of the first and second TBs corresponds to one of an initial transmission of a TB or a retransmission of a previous TB.

In some examples, to support receiving the control signal, the Incremental Redundancy Parameter Component 935 is capable of, configured to, or operable to support a means for receiving the control signal indicating the first and second sets of incremental redundancy parameters, where each of the first and second sets of incremental redundancy parameters includes one or more respective HARQ parameters for a respective TB of the first and second TBs, one or more respective coding parameters for the respective TB of the first and second TBs, or a combination thereof.

In some examples, to support receiving the control signal, the Scheduling Parameter Component 940 is capable of, configured to, or operable to support a means for receiving, as part of the first and second sets of scheduling parameters, an indication of a first allocation size for the first TB and a second allocation size for the second TB, where the first and second allocation sizes are indicated by a respective portion of an allocation granularity.

In some examples, to support receiving the control signal, the Bitmap Indication Component 945 is capable of, configured to, or operable to support a means for receiving an indication of a bitmap for one or more CBGs based on a feedback procedure for at least one of the first TB and the second TB being CBG based feedback.

In some examples, to support receiving the control signal, the Bitmap Indication Component 950 is capable of, configured to, or operable to support a means for receiving an indication of a bitmap for one or more CBs based on a feedback procedure for at least one of the first TB and the second TB being CB based feedback.

In some examples, to support receiving the control signal, the Scheduling Parameter Component 940 is capable of, configured to, or operable to support a means for receiving, as part of the first and second sets of scheduling parameters, an indication of an initial TB size corresponding to one or more initial TBs, where the initial TB corresponds to an initial transmission of at least the first TB or the second TB, and where the initial TB size is based on a total resource allocation of the downlink resource allocation.

In some examples, to support receiving the control signal, the Scheduling Parameter Component 940 is capable of, configured to, or operable to support a means for receiving, as part of the first and second sets of scheduling parameters, an indication of an initial TB size corresponding to one or more initial TBs, where the initial TB corresponds to an initial transmission of at least the first TB or the second TB, and where the initial TB size is based on a fraction of a total resource allocation of the downlink resource allocation.

In some examples, to support receiving the control signal, the Scheduling Parameter Component 940 is capable of, configured to, or operable to support a means for receiving, as part of the first and second sets of scheduling parameters, a retransmission scheduling granularity for the first TB and the second TB.

In some examples, the retransmission scheduling granularity corresponds to one of a TB based retransmission scheduling granularity, a CB based retransmission scheduling granularity, or a CBG based retransmission scheduling granularity.

In some examples, the Scheduling Parameter Component 940 is capable of, configured to, or operable to support a means for receiving, as part of the first and second sets of scheduling parameters, a respective feedback granularity for each of the first TB and the second TB. In some examples, the TB Feedback Component 955 is capable of, configured to, or operable to support a means for transmitting a feedback message indicating feedback for at least one of the first TB and the second TB based on the monitoring, where the feedback message is in accordance with the respective feedback granularity.

In some examples, to support receiving the control signal, the Incremental Redundancy Parameter Component 960 is capable of, configured to, or operable to support a means for receiving an indication of whether the first set of incremental redundancy parameters or the second set of incremental redundancy parameters are fixed or dynamic.

In some examples, the control signal includes one or more scheduling parameters common to both the first TB and the second TB. In some examples, the first and second sets of scheduling parameters are different.

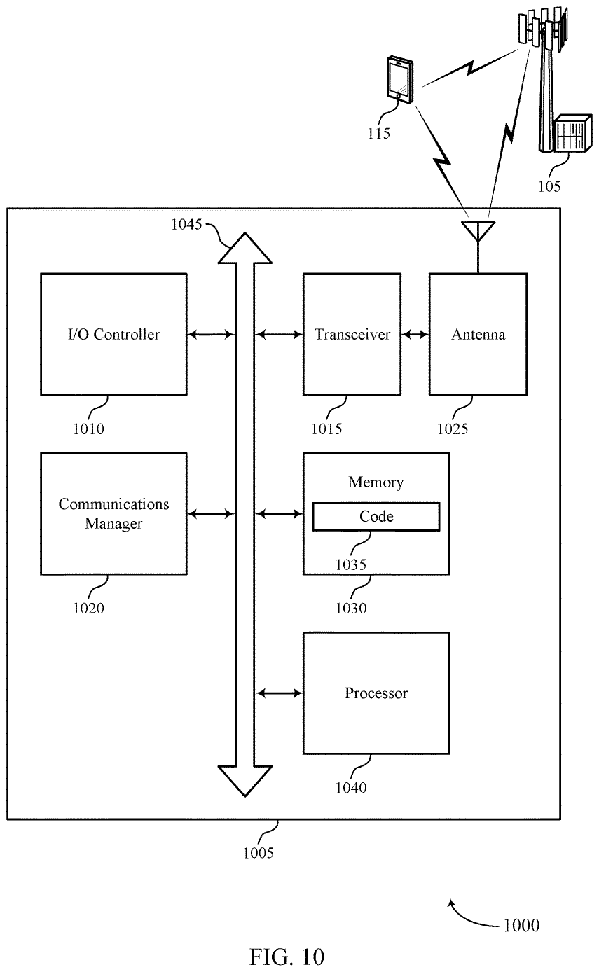

FIG. 10 shows a diagram of a system 1000 including a device 1005 that supports framework for multiple TB scheduling in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting framework for multiple TB scheduling). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 is capable of, configured to, or operable to support a means for receiving a control signal indicating a first set of scheduling parameters for transmission of a first TB via a downlink resource allocation according to a MIRS and indicating a second set of scheduling parameters for transmission of a second TB via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The communications manager 1020 is capable of, configured to, or operable to support a means for monitoring, via the downlink resource allocation in accordance with the first and second sets of scheduling parameters, for the first and second TBs based on the first set of incremental redundancy parameters and the second set of incremental redundancy parameters.

By including or configuring the communications manager 1020 in accordance with examples as described herein, the device 1005 may support techniques for reduced latency, more efficient utilization of communication resources, improved coordination between devices, decreased overhead, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of framework for multiple TB scheduling as described herein, or the processor 1040 and the memory 1030 may be otherwise configured to perform or support such operations.

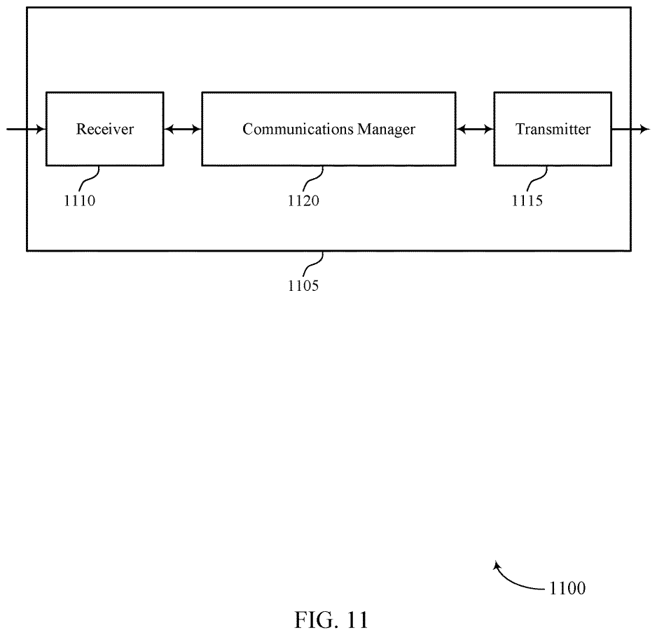

FIG. 11 shows a block diagram 1100 of a device 1105 that supports framework for multiple TB scheduling in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of framework for multiple TB scheduling as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 is capable of, configured to, or operable to support a means for transmitting a control signal indicating a first set of scheduling parameters for transmission of a first TB to a UE via a downlink resource allocation according to a MIRS and indicating a second set of scheduling parameters for transmission of a second TB to the UE via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The communications manager 1120 is capable of, configured to, or operable to support a means for transmitting, via the downlink resource allocation in accordance with the first and second sets of scheduling parameters, the first and second TBs based on the first set of incremental redundancy parameters and the second set of incremental redundancy parameters.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources.

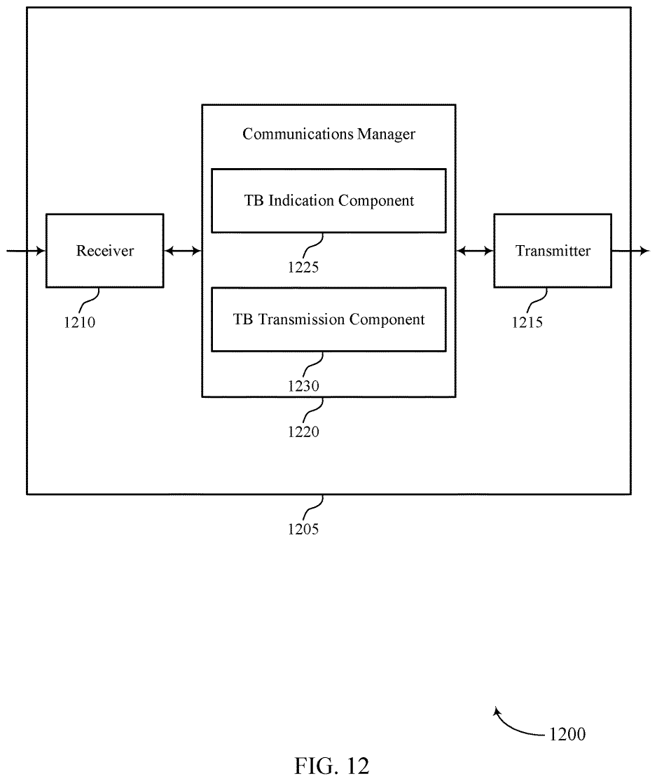

FIG. 12 shows a block diagram 1200 of a device 1205 that supports framework for multiple TB scheduling in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas.

Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of framework for multiple TB scheduling as described herein. For example, the communications manager 1220 may include a TB Indication Component 1225 a TB Transmission Component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The TB Indication Component 1225 is capable of, configured to, or operable to support a means for transmitting a control signal indicating a first set of scheduling parameters for transmission of a first TB to a UE via a downlink resource allocation according to a MIRS and indicating a second set of scheduling parameters for transmission of a second TB to the UE via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The TB Transmission Component 1230 is capable of, configured to, or operable to support a means for transmitting, via the downlink resource allocation in accordance with the first and second sets of scheduling parameters, the first and second TBs based on the first set of incremental redundancy parameters and the second set of incremental redundancy parameters.

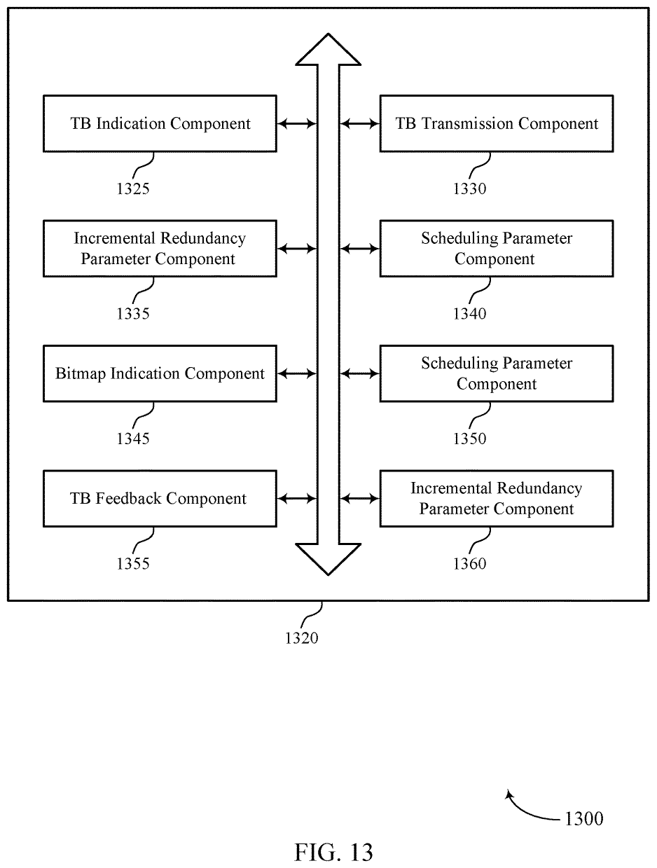

FIG. 13 shows a block diagram 1300 of a communications manager 1320 that supports framework for multiple TB scheduling in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of framework for multiple TB scheduling as described herein. For example, the communications manager 1320 may include a TB Indication Component 1325, a TB Transmission Component 1330, an Incremental Redundancy Parameter Component 1335, a Scheduling Parameter Component 1340, a Bitmap Indication Component 1345, a Scheduling Parameter Component 1350, a TB Feedback Component 1355, an Incremental Redundancy Parameter Component 1360, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The TB Indication Component 1325 is capable of, configured to, or operable to support a means for transmitting a control signal indicating a first set of scheduling parameters for transmission of a first TB to a UE via a downlink resource allocation according to a MIRS and indicating a second set of scheduling parameters for transmission of a second TB to the UE via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The TB Transmission Component 1330 is capable of, configured to, or operable to support a means for transmitting, via the downlink resource allocation in accordance with the first and second sets of scheduling parameters, the first and second TBs based on the first set of incremental redundancy parameters and the second set of incremental redundancy parameters.

In some examples, to support transmitting the control signal, the TB Indication Component 1325 is capable of, configured to, or operable to support a means for transmitting the control signal indicating a set of channel bits associated with the first and second TBs, where each of the first and second TBs corresponds to one of an initial transmission of a TB or a retransmission of a previous TB.

In some examples, to support transmitting the control signal, the Incremental Redundancy Parameter Component 1335 is capable of, configured to, or operable to support a means for transmitting the control signal indicating the first and second sets of incremental redundancy parameters, where each of the first and second sets of incremental redundancy parameters includes one or more respective HARQ parameters for a respective TB of the first and second TBs, one or more respective coding parameters for the respective TB of the first and second TBs, or a combination thereof.

In some examples, to support transmitting the control signal, the Scheduling Parameter Component 1340 is capable of, configured to, or operable to support a means for transmitting, as part of the first and second sets of scheduling parameters, an indication of a first allocation size for the first TB and a second allocation size for the second TB, where the first and second allocation sizes are indicated by a respective portion of an allocation granularity.

In some examples, to support transmitting the control signal, the Bitmap Indication Component 1345 is capable of, configured to, or operable to support a means for transmitting an indication of a bitmap for one or more CBGs based on a feedback procedure for at least one of the first TB and the second TB being CBG based feedback.

In some examples, to support transmitting the control signal, the Bitmap Indication Component 1345 is capable of, configured to, or operable to support a means for transmitting an indication of a bitmap for one or more CBs based on a feedback procedure for at least one of the first TB and the second TB being CB based feedback.

In some examples, to support transmitting the control signal, the Scheduling Parameter Component 1350 is capable of, configured to, or operable to support a means for transmitting, as part of the first and second sets of scheduling parameters, an indication of an initial TB size corresponding to one or more initial TBs, where the initial TB corresponds to an initial transmission of at least the first TB or the second TB, and where the initial TB size is based on a total resource allocation of the downlink resource allocation.

In some examples, to support transmitting the control signal, the Scheduling Parameter Component 1350 is capable of, configured to, or operable to support a means for transmitting, as part of the first and second sets of scheduling parameters, an indication of an initial TB size corresponding to one or more initial TBs, where the initial TB corresponds to an initial transmission of at least the first TB or the second TB, and where the initial TB size is based on a fraction of a total resource allocation of the downlink resource allocation.

In some examples, to support transmitting the control signal, the Scheduling Parameter Component 1350 is capable of, configured to, or operable to support a means for transmitting, as part of the first and second sets of scheduling parameters, a retransmission scheduling granularity for the first TB and the second TB.

In some examples, the retransmission scheduling granularity corresponds to one of a TB based retransmission scheduling granularity, a CB based retransmission scheduling granularity, or a CBG based retransmission scheduling granularity.

In some examples, the Scheduling Parameter Component 1350 is capable of, configured to, or operable to support a means for transmitting, as part of the first and second sets of scheduling parameters, a respective feedback granularity for each of the first TB and the second TB. In some examples, the TB Feedback Component 1355 is capable of, configured to, or operable to support a means for receiving, from the UE, a feedback message indicating feedback for at least one of the first TB and the second TB based on transmitting the first and second TBs, where the feedback message is in accordance with the respective feedback granularity.

In some examples, to support transmitting the control signal, the Incremental Redundancy Parameter Component 1360 is capable of, configured to, or operable to support a means for transmitting an indication of whether the first set of incremental redundancy parameters or the second set of incremental redundancy parameters are fixed or dynamic.

In some examples, the control signal includes one or more scheduling parameters common to both the first TB and the second TB. In some examples, the first and second sets of scheduling parameters are different.

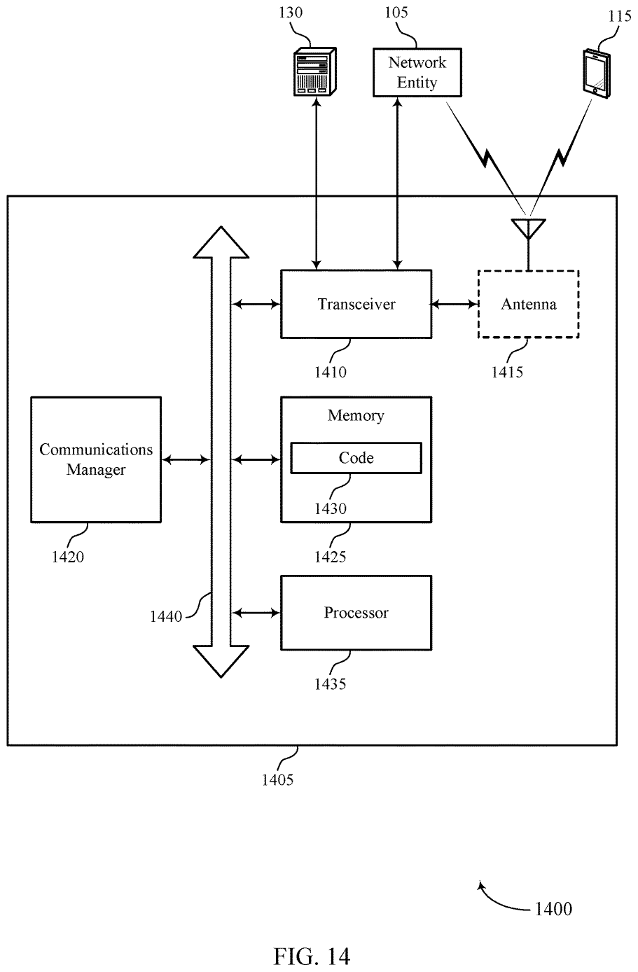

FIG. 14 shows a diagram of a system 1400 including a device 1405 that supports framework for multiple TB scheduling in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting framework for multiple TB scheduling). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 is capable of, configured to, or operable to support a means for transmitting a control signal indicating a first set of scheduling parameters for transmission of a first TB to a UE via a downlink resource allocation according to a MIRS and indicating a second set of scheduling parameters for transmission of a second TB to the UE via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The communications manager 1420 is capable of, configured to, or operable to support a means for transmitting, via the downlink resource allocation in accordance with the first and second sets of scheduling parameters, the first and second TBs based on the first set of incremental redundancy parameters and the second set of incremental redundancy parameters.

By including or configuring the communications manager 1420 in accordance with examples as described herein, the device 1405 may support techniques for reduced latency, reduced power consumption, more efficient utilization of communication resources, improved coordination between devices, reduced overhead, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of framework for multiple TB scheduling as described herein, or the processor 1435 and the memory 1425 may be otherwise configured to perform or support such operations.

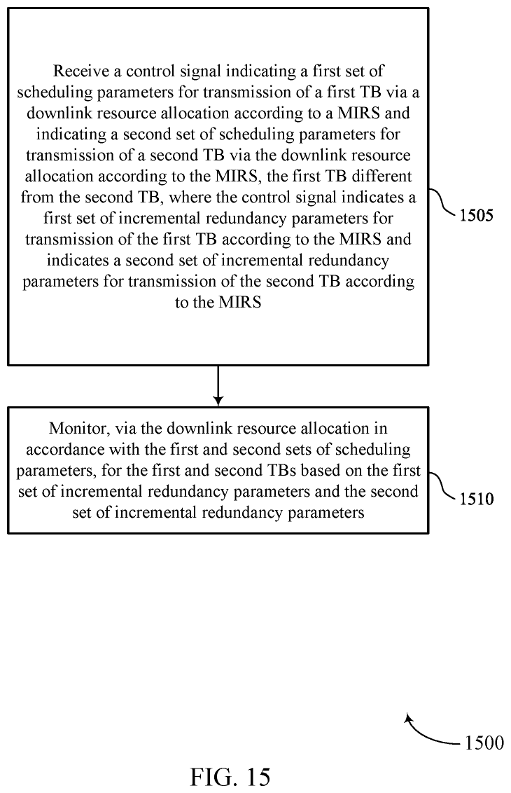

FIG. 15 shows a flowchart illustrating a method 1500 that supports framework for multiple TB scheduling in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a control signal indicating a first set of scheduling parameters for transmission of a first TB via a downlink resource allocation according to a MIRS and indicating a second set of scheduling parameters for transmission of a second TB via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The operations of block 1505 may be performed in accordance with examples as disclosed herein. In some examples, aspects of the operations of 1505 may be performed by a TB Indication Component 925 as described with reference to FIG. 9.

At 1510, the method may include monitoring, via the downlink resource allocation in accordance with the first and second sets of scheduling parameters, for the first and second TBs based on the first set of incremental redundancy parameters and the second set of incremental redundancy parameters. The operations of block 1510 may be performed in accordance with examples as disclosed herein. In some examples, aspects of the operations of 1510 may be performed by a TB Monitoring Component 930 as described with reference to FIG. 9.

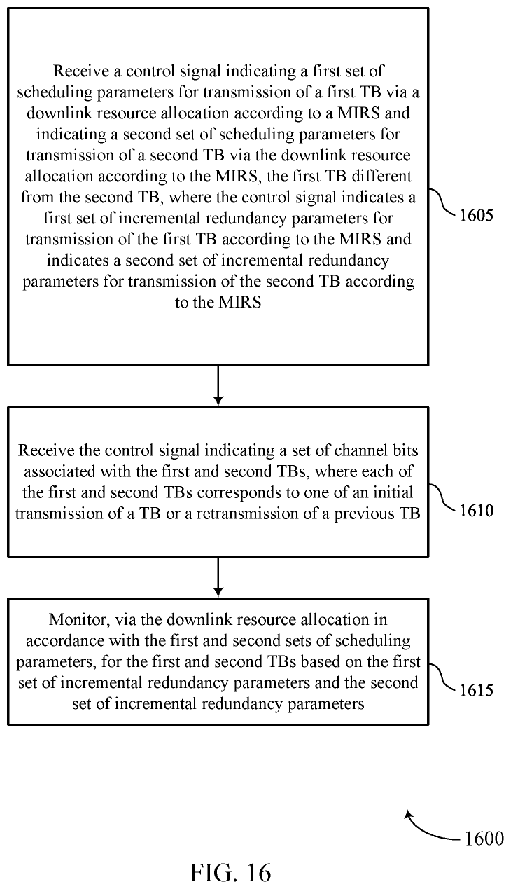

FIG. 16 shows a flowchart illustrating a method 1600 that supports framework for multiple TB scheduling in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a control signal indicating a first set of scheduling parameters for transmission of a first TB via a downlink resource allocation according to a MIRS and indicating a second set of scheduling parameters for transmission of a second TB via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The operations of block 1605 may be performed in accordance with examples as disclosed herein. In some examples, aspects of the operations of 1605 may be performed by a TB Indication Component 925 as described with reference to FIG. 9.

At 1610, the method may include receiving the control signal indicating a set of channel bits associated with the first and second TBs, where each of the first and second TBs corresponds to one of an initial transmission of a TB or a retransmission of a previous TB. The operations of block 1610 may be performed in accordance with examples as disclosed herein. In some examples, aspects of the operations of 1610 may be performed by a TB Indication Component 925 as described with reference to FIG. 9.

At 1615, the method may include monitoring, via the downlink resource allocation in accordance with the first and second sets of scheduling parameters, for the first and second TBs based on the first set of incremental redundancy parameters and the second set of incremental redundancy parameters. The operations of block 1615 may be performed in accordance with examples as disclosed herein. In some examples, aspects of the operations of 1615 may be performed by a TB Monitoring Component 930 as described with reference to FIG. 9.

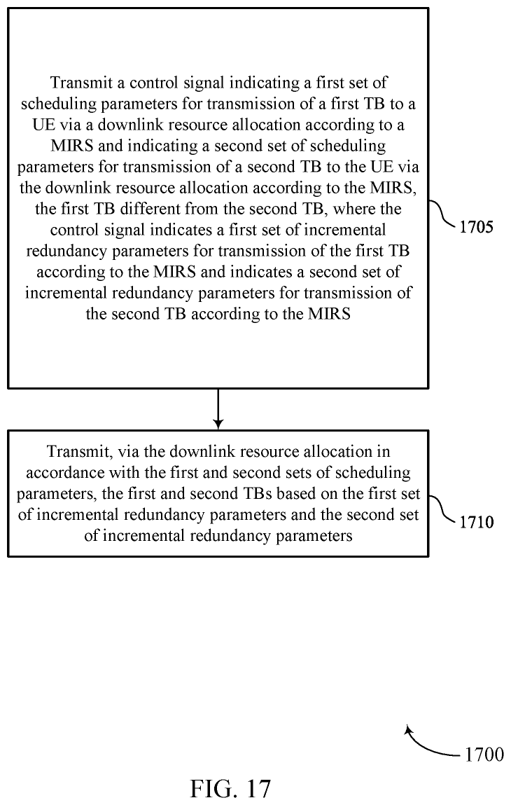

FIG. 17 shows a flowchart illustrating a method 1700 that supports framework for multiple TB scheduling in accordance with aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a control signal indicating a first set of scheduling parameters for transmission of a first TB to a UE via a downlink resource allocation according to a MIRS and indicating a second set of scheduling parameters for transmission of a second TB to the UE via the downlink resource allocation according to the MIRS, the first TB different from the second TB, where the control signal indicates a first set of incremental redundancy parameters for transmission of the first TB according to the MIRS and indicates a second set of incremental redundancy parameters for transmission of the second TB according to the MIRS. The operations of block 1705 may be performed in accordance with examples as disclosed herein. In some examples, aspects of the operations of 1705 may be performed by a TB Indication Component 1325 as described with reference to FIG. 13.

At 1710, the method may include transmitting, via the downlink resource allocation in accordance with the first and second sets of scheduling parameters, the first and second TBs based on the first set of incremental redundancy parameters and the second set of incremental redundancy parameters. The operations of block 1710 may be performed in accordance with examples as disclosed herein. In some examples, aspects of the operations of 1710 may be performed by a TB Transmission Component 1330 as described with reference to FIG. 13.

The following provides an overview of aspects of the present disclosure:

Aspect 1: A method for wireless communications at a UE, comprising: receiving a control signal indicating a first set of scheduling parameters for transmission of a first transport block via a downlink resource allocation according to a multi incremental redundancy scheme and indicating a second set of scheduling parameters for transmission of a second transport block via the downlink resource allocation according to the multi incremental redundancy scheme, the first transport block different from the second transport block, wherein the control signal indicates a first set of incremental redundancy parameters for transmission of the first transport block according to the multi incremental redundancy scheme and indicates a second set of incremental redundancy parameters for transmission of the second transport block according to the multi incremental redundancy scheme; and monitoring, via the downlink resource allocation in accordance with the first and second sets of scheduling parameters, for the first and second transport blocks based at least in part on the first set of incremental redundancy parameters and the second set of incremental redundancy parameters.

Aspect 2: The method of aspect 1, wherein receiving the control signal comprises: receiving the control signal indicating a set of channel bits associated with the first and second transport blocks, wherein each of the first and second transport blocks corresponds to one of an initial transmission of a transport block or a retransmission of a previous transport block.

Aspect 3: The method of any of aspects 1 through 2, wherein receiving the control signal comprises: receiving the control signal indicating the first and second sets of incremental redundancy parameters, wherein each of the first and second sets of incremental redundancy parameters comprises one or more respective hybrid automatic repeat request parameters for a respective transport block of the first and second transport blocks, one or more respective coding parameters for the respective transport block of the first and second transport blocks, or a combination thereof.

Aspect 4: The method of any of aspects 1 through 3, wherein receiving the control signal comprises: receiving, as part of the first and second sets of scheduling parameters, an indication of a first allocation size for the first transport block and a second allocation size for the second transport block, wherein the first and second allocation sizes are indicated by a respective portion of an allocation granularity.

Aspect 5: The method of any of aspects 1 through 4, wherein receiving the control signal comprises: receiving an indication of a bitmap for one or more code block groups based at least in part on a feedback procedure for at least one of the first transport block and the second transport block being code block group based feedback.

Aspect 6: The method of any of aspects 1 through 5, wherein receiving the control signal comprises: receiving an indication of a bitmap for one or more code blocks based at least in part on a feedback procedure for at least one of the first transport block and the second transport block being code block based feedback.

Aspect 7: The method of any of aspects 1 through 6, wherein receiving the control signal comprises: receiving, as part of the first and second sets of scheduling parameters, an indication of an initial transport block size corresponding to one or more initial transport blocks, wherein the one or more initial transport blocks correspond to an initial transmission of at least the first transport block or the second transport block, and wherein the initial transport block size is based at least in part on a total resource allocation of the downlink resource allocation.

Aspect 8: The method of any of aspects 1 through 6, wherein receiving the control signal comprises: receiving, as part of the first and second sets of scheduling parameters, an indication of an initial transport block size corresponding to one or more initial transport blocks, wherein the one or more initial transport blocks correspond to an initial transmission of at least the first transport block or the second transport block, and wherein the initial transport block size is based at least in part on a fraction of a total resource allocation of the downlink resource allocation.

Aspect 9: The method of any of aspects 1 through 8, wherein receiving the control signal comprises: receiving, as part of the first and second sets of scheduling parameters, a retransmission scheduling granularity for the first transport block and the second transport block.

Aspect 10: The method of aspect 9, wherein the retransmission scheduling granularity corresponds to one of a transport block based retransmission scheduling granularity, a code block based retransmission scheduling granularity, or a code block group based retransmission scheduling granularity.

Aspect 11: The method of any of aspects 1 through 10, further comprising: receiving, as part of the first and second sets of scheduling parameters, a respective feedback granularity for each of the first transport block and the second transport block; and transmitting a feedback message indicating feedback for at least one of the first transport block and the second transport block based at least in part on the monitoring, wherein the feedback message is in accordance with the respective feedback granularity.

Aspect 12: The method of any of aspects 1 through 11, wherein receiving the control signal comprises: receiving an indication of whether the first set of incremental redundancy parameters or the second set of incremental redundancy parameters are fixed or dynamic.

Aspect 13: The method of any of aspects 1 through 12, wherein the control signal comprises one or more scheduling parameters common to both the first transport block and the second transport block, and the first and second sets of scheduling parameters are different.

Aspect 14: A method for wireless communications at a network entity, comprising: transmitting a control signal indicating a first set of scheduling parameters for transmission of a first transport block to a UE via a downlink resource allocation according to a multi incremental redundancy scheme and indicating a second set of scheduling parameters for transmission of a second transport block to the UE via the downlink resource allocation according to the multi incremental redundancy scheme, the first transport block different from the second transport block, wherein the control signal indicates a first set of incremental redundancy parameters for transmission of the first transport block according to the multi incremental redundancy scheme and indicates a second set of incremental redundancy parameters for transmission of the second transport block according to the multi incremental redundancy scheme; and transmitting, via the downlink resource allocation in accordance with the first and second sets of scheduling parameters, the first and second transport blocks based at least in part on the first set of incremental redundancy parameters and the second set of incremental redundancy parameters.

Aspect 15: The method of aspect 14, wherein transmitting the control signal comprises: transmitting the control signal indicating a set of channel bits associated with the first and second transport blocks, wherein each of the first and second transport blocks corresponds to one of an initial transmission of a transport block or a retransmission of a previous transport block.

Aspect 16: The method of any of aspects 14 through 15, wherein transmitting the control signal comprises: transmitting the control signal indicating the first and second sets of incremental redundancy parameters, wherein each of the first and second sets of incremental redundancy parameters comprises one or more respective hybrid automatic repeat request parameters for a respective transport block of the first and second transport blocks, one or more respective coding parameters for the respective transport block of the first and second transport blocks, or a combination thereof.

Aspect 17: The method of any of aspects 14 through 16, wherein transmitting the control signal comprises: transmitting, as part of the first and second sets of scheduling parameters, an indication of a first allocation size for the first transport block and a second allocation size for the second transport block, wherein the first and second allocation sizes are indicated by a respective portion of an allocation granularity.

Aspect 18: The method of any of aspects 14 through 17, wherein transmitting the control signal comprises: transmitting an indication of a bitmap for one or more code block groups based at least in part on a feedback procedure for at least one of the first transport block and the second transport block being code block group based feedback.

Aspect 19: The method of any of aspects 14 through 18, wherein transmitting the control signal comprises: transmitting an indication of a bitmap for one or more code blocks based at least in part on a feedback procedure for at least one of the first transport block and the second transport block being code block based feedback.

Aspect 20: The method of any of aspects 14 through 19, wherein transmitting the control signal comprises: transmitting, as part of the first and second sets of scheduling parameters, an indication of an initial TB size corresponding to one or more initial transport blocks, wherein the one or more initial transport blocks correspond to an initial transmission of at least the first transport block or the second transport block, and wherein the initial transport block size is based at least in part on a total resource allocation of the downlink resource allocation.

Aspect 21: The method of any of aspects 14 through 19, wherein transmitting the control signal comprises: transmitting, as part of the first and second sets of scheduling parameters, an indication of an initial transport block size corresponding to one or more initial transport blocks, wherein the one or more initial transport blocks correspond to an initial transmission of at least the first transport block or the second transport block, and wherein the initial transport block size is based at least in part on a fraction of a total resource allocation of the downlink resource allocation.

Aspect 22: The method of any of aspects 14 through 21, wherein transmitting the control signal comprises: transmitting, as part of the first and second sets of scheduling parameters, a retransmission scheduling granularity for the first transport block and the second transport block.

Aspect 23: The method of aspect 22, wherein the retransmission scheduling granularity corresponds to one of a transport block based retransmission scheduling granularity, a code block based retransmission scheduling granularity, or a code block group based retransmission scheduling granularity.

Aspect 24: The method of any of aspects 14 through 23, further comprising: transmitting, as part of the first and second sets of scheduling parameters, a respective feedback granularity for each of the first transport block and the second transport block; and receiving, from the UE, a feedback message indicating feedback for at least one of the first transport block and the second transport block based at least in part on transmitting the first and second transport blocks, wherein the feedback message is in accordance with the respective feedback granularity.

Aspect 25: The method of any of aspects 14 through 24, wherein transmitting the control signal comprises: transmitting an indication of whether the first set of incremental redundancy parameters or the second set of incremental redundancy parameters are fixed or dynamic.

Aspect 26: The method of any of aspects 14 through 25, wherein the control signal comprises one or more scheduling parameters common to both the first transport block and the second transport block, and the first and second sets of scheduling parameters are different.

Aspect 27: An apparatus for wireless communications at a UE, comprising a processor; memory coupled with the processor; and instructions stored in the memory and executable by the processor to cause the apparatus to perform a method of any of aspects 1 through 13.

Aspect 28: An apparatus for wireless communications at a UE, comprising at least one means for performing a method of any of aspects 1 through 13.

Aspect 29: A non-transitory computer-readable medium storing code for wireless communications at a UE, the code comprising instructions executable by a processor to perform a method of any of aspects 1 through 13.

Aspect 30: An apparatus for wireless communications at a network entity, comprising a processor; memory coupled with the processor; and instructions stored in the memory and executable by the processor to cause the apparatus to perform a method of any of aspects 14 through 26.

Aspect 31: An apparatus for wireless communications at a network entity, comprising at least one means for performing a method of any of aspects 14 through 26.

Aspect 32: A non-transitory computer-readable medium storing code for wireless communications at a network entity, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor;
memory coupled with the processor; and
instructions stored in the memory and executable by the processor to cause the apparatus to:
receive a control signal indicating a first set of scheduling parameters for transmission of a first transport block via a downlink resource allocation according to a multi incremental redundancy scheme and indicating a second set of scheduling parameters for transmission of a second transport block via the downlink resource allocation according to the multi incremental redundancy scheme, the first transport block different from the second transport block, wherein the control signal indicates a first set of incremental redundancy parameters for transmission of the first transport block according to the multi incremental redundancy scheme and indicates a second set of incremental redundancy parameters for transmission of the second transport block according to the multi incremental redundancy scheme; and
monitor, via the downlink resource allocation in accordance with the first and second sets of scheduling parameters, for the first and second transport blocks based at least in part on the first set of incremental redundancy parameters and the second set of incremental redundancy parameters.

2. The apparatus of claim 1, wherein the instructions to receive the control signal are executable by the processor to cause the apparatus to:
receive the control signal indicating a set of channel bits associated with the first and second transport blocks, wherein each of the first and second transport blocks corresponds to one of an initial transmission of a transport block or a retransmission of a previous transport block.

3. The apparatus of claim 1, wherein the instructions to receive the control signal are executable by the processor to cause the apparatus to:
receive the control signal indicating the first and second sets of incremental redundancy parameters, wherein each of the first and second sets of incremental redundancy parameters comprises one or more respective hybrid automatic repeat request parameters for a respective transport block of the first and second transport blocks, one or more respective coding parameters for the respective transport block of the first and second transport blocks, or a combination thereof.

4. The apparatus of claim 1, wherein the instructions to receive the control signal are executable by the processor to cause the apparatus to:
receive, as part of the first and second sets of scheduling parameters, an indication of a first allocation size for the first transport block and a second allocation size for the second transport block, wherein the first and second allocation sizes are indicated by a respective portion of an allocation granularity.

5. The apparatus of claim 1, wherein the instructions to receive the control signal are executable by the processor to cause the apparatus to:
receive an indication of a bitmap for one or more code block groups based at least in part on a feedback procedure for at least one of the first transport block and the second transport block being code block group based feedback.

6. The apparatus of claim 1, wherein the instructions to receive the control signal are executable by the processor to cause the apparatus to:
receive an indication of a bitmap for one or more code blocks based at least in part on a feedback procedure for at least one of the first transport block and the second transport block being code block based feedback.

7. The apparatus of claim 1, wherein the instructions to receive the control signal are executable by the processor to cause the apparatus to:
receive, as part of the first and second sets of scheduling parameters, an indication of an initial transport block size corresponding to one or more initial transport blocks, wherein the one or more initial transport blocks correspond to an initial transmission of at least the first transport block or the second transport block, and wherein the initial transport block size is based at least in part on a total resource allocation of the downlink resource allocation.

8. The apparatus of claim 1, wherein the instructions to receive the control signal are executable by the processor to cause the apparatus to:
receive, as part of the first and second sets of scheduling parameters, an indication of an initial transport block size corresponding to one or more initial transport blocks, wherein the one or more initial transport blocks correspond to an initial transmission of at least the first transport block or the second transport block, and wherein the initial transport block size is based at least in part on a fraction of a total resource allocation of the downlink resource allocation.

9. The apparatus of claim 1, wherein the instructions to receive the control signal are executable by the processor to cause the apparatus to:
receive, as part of the first and second sets of scheduling parameters, a retransmission scheduling granularity for the first transport block and the second transport block.

10. The apparatus of claim 9, wherein the retransmission scheduling granularity corresponds to one of a transport block based retransmission scheduling granularity, a code block based retransmission scheduling granularity, or a code block group based retransmission scheduling granularity.

11. The apparatus of claim 1, wherein the instructions are further executable by the processor to cause the apparatus to:
receive, as part of the first and second sets of scheduling parameters, a respective feedback granularity for each of the first transport block and the second transport block; and
transmit a feedback message indicating feedback for at least one of the first transport block and the second transport block based at least in part on the monitoring, wherein the feedback message is in accordance with the respective feedback granularity.

12. The apparatus of claim 1, wherein the instructions to receive the control signal are executable by the processor to cause the apparatus to:
receive an indication of whether the first set of incremental redundancy parameters or the second set of incremental redundancy parameters are fixed or dynamic.

13. The apparatus of claim 1, wherein the control signal comprises one or more scheduling parameters common to both the first transport block and the second transport block, and wherein the first and second sets of scheduling parameters are different.

14. An apparatus for wireless communications at a network entity, comprising:
a processor;
memory coupled with the processor; and
instructions stored in the memory and executable by the processor to cause the apparatus to:
transmit a control signal indicating a first set of scheduling parameters for transmission of a first transport block to a user equipment (UE) via a downlink resource allocation according to a multi incremental redundancy scheme and indicating a second set of scheduling parameters for transmission of a second transport block to the UE via the downlink resource allocation according to the multi incremental redundancy scheme, the first transport block different from the second transport block, wherein the control signal indicates a first set of incremental redundancy parameters for transmission of the first transport block according to the multi incremental redundancy scheme and indicates a second set of incremental redundancy parameters for transmission of the second transport block according to the multi incremental redundancy scheme; and
transmit, via the downlink resource allocation in accordance with the first and second sets of scheduling parameters, the first and second transport blocks based at least in part on the first set of incremental redundancy parameters and the second set of incremental redundancy parameters.

15. The apparatus of claim 14, wherein the instructions to transmit the control signal are executable by the processor to cause the apparatus to:
transmit the control signal indicating a set of channel bits associated with the first and second transport blocks, wherein each of the first and second transport blocks corresponds to one of an initial transmission of a transport block or a retransmission of a previous transport block.

16. The apparatus of claim 14, wherein the instructions to transmit the control signal are executable by the processor to cause the apparatus to:
transmit the control signal indicating the first and second sets of incremental redundancy parameters, wherein each of the first and second sets of incremental redundancy parameters comprises one or more respective hybrid automatic repeat request parameters for a respective transport block of the first and second transport blocks, one or more respective coding parameters for the respective transport block of the first and second transport blocks, or a combination thereof.

17. The apparatus of claim 14, wherein the instructions to transmit the control signal are executable by the processor to cause the apparatus to:
transmit, as part of the first and second sets of scheduling parameters, an indication of a first allocation size for the first transport block and a second allocation size for the second transport block, wherein the first and second allocation sizes are indicated by a respective portion of an allocation granularity.

18. The apparatus of claim 14, wherein the instructions to transmit the control signal are executable by the processor to cause the apparatus to:
transmit an indication of a bitmap for one or more code block groups based at least in part on a feedback procedure for at least one of the first transport block and the second transport block being code block group based feedback.

19. The apparatus of claim 14, wherein the instructions to transmit the control signal are executable by the processor to cause the apparatus to:
transmit an indication of a bitmap for one or more code blocks based at least in part on a feedback procedure for at least one of the first transport block and the second transport block being code block based feedback.

20. The apparatus of claim 14, wherein the instructions to transmit the control signal are executable by the processor to cause the apparatus to:
transmit, as part of the first and second sets of scheduling parameters, an indication of an initial transport block size corresponding to one or more initial transport blocks, wherein the one or more initial transport blocks correspond to an initial transmission of at least the first transport block or the second transport block, and wherein the initial transport block size is based at least in part on a total resource allocation of the downlink resource allocation.

21-30. (canceled)
